(19) United States
(12) Patent Application Publication
(10) Pub. No.: US 2009/0129358 A1
(43) Pub. Date: May 21, 2009

(54) Communication Apparatus, Communication Method and Program

(75) Inventor: Akira Miyashita, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/887,566

(22) PCT Filed: Mar. 29, 2006
(86) PCT No.: PCT/JP2006/306545

§ 371 Date: Sep. 28, 2007

(30) Foreign Application Priority Data
Mar. 31, 2005 (JP) 2005-101526
Sep. 26, 2005 (JP) 2005-277185

(51) Int. Cl. H04B 7/216

(52) U.S. Cl. 370/342

(57) ABSTRACT

A communication apparatus, which has a means for allowing communication to be performed via one or more lines, decides a timing at which to perform a reconnection, taking the statuses of the lines into account. When the timing at which to perform the reconnection has been decided, a line is disconnected once, and then the line is reconnected. This allows the communication apparatus to attempt to switch to a higher-rate communication mode, maintain the connectivity of the communication apparatus and to secure a higher-rate communication mode line, whereby the communication apparatus can use an increased number of bands as a whole.

### APPLICABLE FIELD IN THE INDUSTRY

The present invention relates to a technology of switching a communication mode in a communication apparatus using one link or more that supports different communication modes.

### BACKGROUND ART

At present, wireless IFs (interfaces), which are used for making communication by employing a communication carrier wireless system in a communication apparatus, are being marketed in general. The wireless IF that corresponds to a plurality of the different communication modes and appropriately switches the communication mode being used is included in these wireless IFs.

Herein, the so-called communication mode signifies a communication class that is comprised of a communication rate and a communication technique. For example, in a W-CDMA communication technique that is represented by FOMA, the service of which the communication rate is 64 kbps and 384 kbps is provided, and in this case, there exist two kinds of the communication modes, that is, one is the low-rate communication mode of which the communication technique is W-CDMA, and of which the communication rate is 64 kbps, and the other is the high-rate communication mode of which the communication technique is W-CDMA, and of which the communication rate is 384 kbps.

As a wireless IF for appropriately switching the communication mode that is used in such a manner, for example, in Patent document 1, the wireless IF is described for realizing a switchover from a 3G wireless system of which the communication mode is a high-rate one to a 2G wireless system of which the communication mode is a low-rate one for both of the high-rate 3G wireless system and the low-rate 2G wireless system. This switchover from this 3G wireless system to the 2G wireless system is realized in a manner mentioned below.

At first, in a control channel of the 3G wireless system, information on available control channels of the 2G wireless system is notified to the wireless IF from a network side. The wireless IF employs the notified information on the control channel of the 2G wireless system, thereby to retrieve a synchronized channel of the 2G wireless system. This enables the wireless IF to retrieve the synchronized channel in a short time in a case of having migrated to a cover area of the 2G wireless system from that of the 3G wireless system, whereby the switchover to the high-rate wireless system is realized. On the other hand, how to make a switchover to the communication mode of the 3G wireless system from that of the low-rate 2G wireless system in the case of having returned to the cover area of the high-rate 3G wireless system is not described in particular.

Further, in Patent document 2, the technique is disclosed of selecting an optimal communication mode from among a plurality of the communication modes each having a different communication rate responding to the reception power level of the signal, and using it. In this case, not only the switchover to the low-rate communication mode from the high-rate communication mode but also the switchover to the high-rate communication mode from the low-rate communication mode is realized.

[Patent document 1] JP-P2002-535902

[Patent document 2] JP-P2003-506902

### DISCLOSURE OF THE INVENTION

### Problems to be Solved by the Invention

However, the inventions disclosed in the above-mentioned documents have the following problems.

The first problem is that even in a case where the communication mode is switched by means of the network side's control disclosed in the Patent document 1, the sufficient band cannot be secured notwithstanding the status that the wide band can be secured because the control is exclusively taken in a such a manner that the band is narrowed, and is not taken in a such a manner that the band is widened.

For example, in a carrier network in which the band is not assigned in such a manner that the band is widened, there is a problem that the sufficient band cannot be secured even in a status where the wide band can be secured.

Further, the technique of switching the communication mode described in the Patent document 2 also cannot solve the above-mentioned problem in a case where the wireless IF being used is not provided with API (Application Program Interface) for switching the communication mode because the communication mode cannot be switched by means of the communication apparatus side's control. In particular, in the case that the line continues to be used for a long time, for example, in a fixed connection environment, the possibility that the communication band migrates to the different environment becomes high, which makes this problem conspicuous.

The second problem is that the status of communication interruption might occurs in the technique of switching the communication mode described in the Patent document 1 and the Patent document 2, which do not describe the case that one communication apparatus includes a plurality of the wireless IFs, because if one communication apparatus includes a plurality of the wireless IFs, all of the wireless IFs, each of which independently switches the communication mode, could perform a switchover process simultaneously.

Thereupon, the present invention has been accomplished in consideration of the above-mentioned problems, and an object thereof is to provide a technology of switching the communication mode in such a manner that the band is widened in the wireless IF that does not include the API for switching the communication mode.

Further, another object of the present invention is to provide a technology of switching the communication mode in a such a manner that the band is further widened without causing the lines, of which the number is equal to or more than a constant, to come into a status of communication interruption in a case where one communication apparatus includes a plurality of the wireless IFs.

Further, another object of the present invention is to provide a technology that enables the communication mode to be switched in a communication apparatus in such a manner that the band is widened with respect to a carrier network in which the band is not assigned in such a manner that the band is widened.

The 1st invention for solving the above-mentioned task, which is a communication apparatus for using a line that corresponds to a plurality of communication modes and making communication, characterized in comprising a reconnection controlling means for disconnecting a line, and reconnecting the line with a connectee of said disconnected line.

The 2nd invention for solving the above-mentioned task, which is a communication apparatus for combining lines each corresponding to a plurality of communication modes, configuring one logical line between transmission and reception, and making communication by employing said one logical line, characterized in comprising a reconnection controlling means for disconnecting at least one line, out of the lines constituting said one logical line, and reconnecting the line with a connectee of said disconnected line.

The 3rd invention for solving the above-mentioned task, in 1st or 2nd inventions, which is characterized in that said reconnection controlling means comprises: a line status monitoring means for monitoring a line status of the connected line; a reconnection timing determining means for determining a timing of the reconnection based upon a monitoring result by said line status monitoring means; and a link controlling means for disconnecting the line based upon a determination by said reconnection timing determining means, and reconnecting the line with the connectee of said disconnected line.

The 4th invention for solving the above-mentioned task, in one of the above-mentioned 1st to 3rd inventions, which is characterized in that said reconnection controlling means comprises: a communication mode estimating means for estimating a communication mode of the connected line; a reconnection timing determining means for, in a case where an estimation result by said communication mode estimating means demonstrates that the communication mode is a low-rate communication mode, determining that the reconnection should be performed; and a link controlling means for disconnecting the line based upon a determination by said reconnection timing determining means and reconnecting the line with the connectee of said disconnected line.

The 5th invention for solving the above-mentioned task, in one of the above-mentioned 1st to 4th inventions, which is characterized in that said reconnection controlling means comprises: a connection status acquiring means for detecting the number of the lines in a disconnection status; a reconnection timing determining means for, with the predetermined number of the lines in a disconnection status assumed to be a criterion for determining the reconnection, determining that the reconnection should be performed when the number of the lines in a disconnection status, being a detection result by said connection status acquiring means, is less than said criterion for determining the reconnection; and a link controlling means for disconnecting the line based upon a determination by said reconnection timing determining means and reconnecting the line with the connectee of said disconnected line.

The 6th invention for solving the above-mentioned task, in one of the above-mentioned 1st to 5th inventions, which is characterized in that said reconnection controlling means comprises: a band information acquiring means for detecting a communication band value of the connected line; a reconnection timing determining means for, with a predetermined total communication band value assumed to be a criterion for determining the reconnection, determining that the reconnection should be performed when a total value of the lines other than the line being reconnected, being an acquisition result by said band information acquiring means, is more than said criterion for determining the reconnection; and a link controlling means for disconnecting the line based upon a determination by said reconnection timing determining means and reconnecting the line with the connectee of said disconnected line.

The 7th invention for solving the above-mentioned task, in one of the above-mentioned 1st to 6th inventions, which is characterized in that said reconnection controlling means comprises: a radio-wave reception quality acquiring means for acquiring a reception quality of a radio wave of the line; a reconnection timing determining means for, with a predetermined reception quality of a radio wave assumed to be a criterion for determining the reconnection, determining that the reconnection should be performed in a case where the reception quality of a radio wave, being an acquisition result by said radio-wave reception quality acquiring means, is larger than said criterion value for determining the reconnection; and a link controlling means for disconnecting the line based upon a determination by said reconnection timing determining means and reconnecting the line with the connectee of said disconnected line.

The 8th invention for solving the above-mentioned task, in one of the above-mentioned 1st to 7th inventions, which is characterized in that said reconnection controlling means comprises: a communication mode estimating means for detecting the number of the lines using a high-rate communication mode; a position acquiring means for acquiring a current position of the communication apparatus; a reconnection timing determining means for, with the number of the lines, in which the high-rate communication mode can be secured, predetermined at each location assumed to be a criterion for determining the reconnection, determining that the reconnection should be performed in a case where the number of the lines using the high-rate communication mode, being a detection result by said communication mode estimating means, does not reached said criterion value for determining the reconnection at the location acquired by said position acquiring means; and a link controlling means for disconnecting the line based upon a determination by said reconnection timing determining means and reconnecting the line with the connectee of said disconnected line.

The 9th invention for solving the above-mentioned task, in one of the above-mentioned 1st to 8th inventions, which is characterized in that said reconnection controlling means comprises: a migration speed acquiring means for acquiring a migration speed; a reconnection timing determining means for, with a predetermined migration speed assumed to be a criterion for determining the reconnection, determining that the reconnection should be performed in a case where the migration speed, being an acquisition result by said migration speed acquiring means, is lower than said criterion value for determining the reconnection; and a link controlling means for disconnecting the line based upon a determination by said reconnection timing determining means and reconnecting the line with the connectee of said disconnected line.

The 10th invention for solving the above-mentioned task, in one of the above-mentioned 1st to 8th inventions, which is characterized in that said reconnection controlling means comprises: a communication rate acquiring means for acquiring a communication rate per hour of the connected line; a reconnection timing determining means for with a communication rate per hour in a predetermined time assumed to be a criterion for determining the reconnection, determining that the reconnection should be performed in a case where the communication rate per hour, being an acquisition result by said communication rate acquiring means, is larger than said criterion value for determining the reconnection during said predetermined time; and a link controlling means for disconnecting the line based upon a determination by said reconnection timing determining means and reconnecting the line with the connectee of said disconnected line.

The 11th invention for solving the above-mentioned task, which is a communication method of using a line that corresponds to a plurality of communication modes and making communication, characterized in making an attempt to make a switchover to a high-rate communication mode by disconnecting the connected line, and reconnecting the line with a connectee of said disconnected line.

The 12th invention for solving the above-mentioned task, which is a communication method of combining lines each corresponding to a plurality of communication modes, configuring one logical line between transmission and reception, and making communication by employing said one logical line, characterized in making an attempt to make a switchover to a high-rate communication mode by disconnecting at least one line, out of the lines constituting said one logical line, and reconnecting the line with a connectee of said disconnected line.

The 13th invention for solving the above-mentioned task, in the above-mentioned 11th or 12th inventions, which is characterized in monitoring a line status of the connected line, and determining a timing of the reconnection based upon a monitoring result.

The 14th invention for solving the above-mentioned task, in one of the above-mentioned 11th to 13th inventions, which is characterized in estimating a communication mode of the connected line, and performing the reconnection in a case where the estimated communication mode is a low-rate communication mode.

The 15th invention for solving the above-mentioned task, in one of the above-mentioned 11th to 14th inventions, which is characterized in performing the reconnection when the number of the lines in a disconnection status is less than a predetermined number of the lines in a disconnection status.

The 16th invention for solving the above-mentioned task, in one of the above-mentioned 11th to 15th inventions, which is characterized in performing the reconnection when a total communication band value of the lines other than the line that is reconnected is more than a predetermined total communication band value.

The 17th invention for solving the above-mentioned task, in one of the above-mentioned 11th to 14th inventions, which is characterized in performing the reconnection when a radio-wave reception quality of the line is higher than a predetermined radio-wave reception quality.

The 18th invention for solving the above-mentioned task, in one of the above-mentioned 11th to 17th inventions, which is characterized in pre-storing the number of the high-rate communication mode lines that can be secured at each location, and performing the reconnection in case where the number of the high-rate communication mode lines that are being used at a position in which the communication apparatus exists does not reached the number of the high-rate communication mode lines that can be secured in said position.

The 15th invention for solving the above-mentioned task, in one of the above-mentioned 11th to 18th inventions, which is characterized in pre-storing a predetermined migration speed, and performing the reconnection in a case where the migration speed of the communication apparatus is lower than said predetermined migration speed.

The 20th invention for solving the above-mentioned task, in one of the above-mentioned 11th to 19th inventions, which is characterized in pre-storing a

a communication rate per hour of a predetermined time, and performing the reconnection in a case where the communication rate per hour of the connected line during a predetermined time is larger than said stored communication rate per hour.

The 21st invention for solving the above-mentioned task, which is a program of a communication apparatus for using a line that corresponds to a plurality of communication modes, and making communication, characterized in causing said communication apparatus to function as a reconnection controlling means for disconnecting the line, and reconnecting the line with a connectee of said disconnected line.

The 22nd invention for solving the above-mentioned task, which is a program of a communication apparatus for combining lines each corresponding to a plurality of communication modes, configuring one logical line between transmission and reception, and making communication by employing said one logical line, characterized in causing said communication apparatus to function as a reconnection controlling means for disconnecting at least one line, out of the lines constituting said one logical line, and reconnecting the line with a connectee of said disconnected line.

The 23rd invention for solving the above-mentioned task, in one of the above-mentioned 21st or 22nd inventions, which is characterized in causing said reconnection controlling means to function as: a line status monitoring means for monitoring a line status of the connected line; a reconnection timing determining means for determining a timing of the reconnection based upon a monitoring result by said line status monitoring means; and a link controlling means for disconnecting the line based upon a determination by said reconnection timing determining means, and reconnecting the line with the connectee of said disconnected line.

The 24th invention for solving the above-mentioned task, in one of the above-mentioned 21st to 23rd inventions, which is characterized in causing said reconnection controlling means to function as: a communication mode estimating means for estimating a communication mode of the connected line; a reconnection timing determining means for, in a case where an estimation result by said communication mode estimating means demonstrates that the communication mode is a low-rate communication mode, determining that the reconnection should be performed; and a link controlling means for disconnecting the line based upon a determination by said reconnection timing determining means and reconnecting the line with the connectee of said disconnected line.

The 25th invention for solving the above-mentioned task, in one of the above-mentioned 21st to 24th inventions, which is characterized in causing said reconnection controlling means to function as: a connection status acquiring means for detecting the number of the lines in a disconnection status; a reconnection timing determining means for, with the predetermined number of the lines in a disconnection status assumed to be a criterion for determining the reconnection, determining that the reconnection should be performed when the number of the lines in a disconnection status, being a detection result by said connection status acquiring means, is less than said criterion for determining the reconnection; and a link controlling means for disconnecting the line based upon a determination by said reconnection timing determining means and reconnecting the line with the connectee of said disconnected line.

The 26th invention for solving the above-mentioned task, in one of the above-mentioned 21st to 25th inventions, which is characterized in causing said reconnection controlling means to function as: a band information acquiring means for detecting a communication band value of the connected line; a reconnection timing determining means for, with a predetermined total communication band value assumed to be a criterion for determining the reconnection, determining that the reconnection should be performed when a total value of the lines other than the line being reconnected, being an acquisition result by said band information acquiring means, is more than said criterion for determining the reconnection; and a link controlling means for disconnecting the line based upon a determination by said reconnection timing determining means and reconnecting the line with the connectee of said disconnected line.

The 27th invention for solving the above-mentioned task, in one of the above-mentioned 21st to 26th inventions, which is characterized in causing said reconnection controlling means to function as: a radio-wave reception quality acquiring means for acquiring a reception quality of a radio wave of the line; a reconnection timing determining means for, with a predetermined reception quality of a radio wave assumed to be a criterion for determining the reconnection, determining that the reconnection should be performed in a case where the reception quality of a radio wave, being an acquisition result by said radio-wave reception quality acquiring means, is larger than said criterion value for determining the reconnection; and a link controlling means for disconnecting the line based upon a determination by said reconnection timing determining means and reconnecting the line with the connectee of said disconnected line.

The 28th invention for solving the above-mentioned task, in one of the above-mentioned 21st to 27th inventions, which is characterized in causing said reconnection controlling means to function as: a communication mode estimating means for detecting the number of the lines using a high-rate communication mode; a position acquiring means for acquiring a current position of the communication apparatus; a reconnection timing determining means for, with the number of the lines, in which the high-rate communication mode can be secured, predetermined at each location assumed to be a criterion for determining the reconnection, determining that the reconnection should be performed in a case where the number of the lines using the high-rate communication mode, being a detection result by said communication mode estimating means, does not reached said criterion value for determining the reconnection at the location acquired by said position acquiring means; and a link controlling means for disconnecting the line based upon a determination by said reconnection timing determining means and reconnecting the line with the connectee of said disconnected line.

The 29th invention for solving the above-mentioned task, in one of the above-mentioned 21st to 28th inventions, which is characterized in causing said reconnection controlling means to function as: a migration speed acquiring means for acquiring a migration speed; a reconnection timing determining means for, with a predetermined migration speed assumed to be a criterion for determining the reconnection, determining that the reconnection should be performed in a case where the migration speed, being an acquisition result by said migration speed acquiring means, is lower than said criterion value for determining the reconnection; and a link controlling means for disconnecting the line based upon a determination by said reconnection timing determining means and reconnecting the line with the connectee of said disconnected line.

The 30th invention for solving the above-mentioned task, in one of the above-mentioned 21st to 26th inventions, which is characterized in causing said reconnection controlling means to function as: a communication rate acquiring means for acquiring a communication rate per hour of the connected line; a reconnection timing determining means for with a communication rate per hour in a predetermined time assumed to be a criterion for determining the reconnection, determining that the reconnection should be performed in a case where the communication rate per hour, being an acquisition result by said communication rate acquiring means, is larger than said criterion value for determining the reconnection during said predetermined time; and a link controlling means for disconnecting the line based upon a determination by said reconnection timing determining means and reconnecting the line with the connectee of said disconnected line.

The 31st invention for solving the above-mentioned task, which is a server for managing a communication apparatus for using a line that corresponds to a plurality of communication modes, and making communication, characterized in comprising the means of: acquiring a line status of the communication apparatus; deciding a disconnection timing of the line of said communication apparatus based upon said acquired line status; and notifying said disconnection timing of the line to said communication apparatus.

In the present invention, the communication apparatus, which has a means for allowing communication to be made via one or more lines, decides a timing at which to perform a reconnection process, taking the statuses of the lines into account. When the timing at which to perform the reconnection process has been decided, the line is disconnected once more, and then the line is reconnected. With this, it becomes possible to maintain connectivity of the communication apparatus and to secure a higher-rate communication mode line, thereby enabling the available band to be enlarged as a whole.

As a determination criterion for performing the reconnection process, there exist the following cases.

(1) The communication mode of the connected line is a low-rate communication mode.

(2) The number of the lines under disconnection is a constant number or less.

(3) A total value of the communication bands of the lines other than the line that is reconnected is a constant value or more.

(4) A reception quality of a radio wave of the line that is reconnected is equal to or more than a threshold.

(5) The number of the high-rate mode lines that have been already secured in the communication apparatus has not reached an upper limit at a current position.

(6) A migrating speed of the communication apparatus, which is migrating, is equal to or less than a threshold.

(7) A constant traffic or more is allowed to flow into the line that is reconnected for a constant time or more.

Assuming each of these to be a determination criterion for performing the reconnection process makes it possible to alleviate deterioration in the communication performance due to the unnecessary reconnection process.

Additionally, each of these determination criteria may be applied independently, and it is also possible to apply a combination thereof.

### EFFECTS OF THE INVENTION

The first effect of the present invention lies in a point that the band that the communication apparatus can utilize is widened all the more. The reason is that reconnecting the line to which the low-rate communication mode has been assigned by the network side makes it possible to attempt a switchover to the higher-rate communication mode.

The second effect of the present invention lies in a point that, in a case of employing a plurality of the IFs (interfaces) to make communication, even though the communication interruption due to the reconnection occurs to the IF that makes an attempt to secure the high-rate mode, maintaining the communication status by means of the other IF makes it possible to make communication without narrowing the band that can be utilized by the communication apparatus. The reason is that the reconnection for a purpose of making an attempt to secure the high-rate communication mode is executed when the sufficient communication performance can be secured by means of the IFs, which the communication apparatus includes, other than the IF for executing the reconnection, and the deterioration in the communication performance is small as a whole of the communication apparatus.

The reason is that, in particular, the present invention is configured so that the process of the reconnection is performed in a case where the communication mode of the connected line is a low-rate communication mode, and the process of the reconnection is not performed in a case where the communication mode of the connected line is a high-rate communication mode.

Further, the reason is that the present invention is configured so that the process of the reconnection is performed in a case where the number of the lines under disconnection, out of the currently-available lines, is a constant number or less, thereby preventing an increase in the number of the lines under disconnection due to the line disconnection, and preventing the communication band from being narrowed unnecessarily.

Further, the reason is that the present invention is configured so that the process of the reconnection is performed in a case where the total value of the communication band of the lines other than the line that is reconnected is a constant value or more, thereby preventing the total communication band of the lines under connection is prevented from being narrowed due to the line disconnection.

### BRIEF DESCRIPTION OF THE DRAWINGS

FIG. 1 is a view illustrating a network configuration of an example 1.

FIG. 2 is a view illustrating an internal construction of the communication apparatus of the example 1.

FIG. 3 is a flowchart illustrating an operation of the communication apparatus of the example 1

FIG. 4 is a flowchart illustrating an operation of the communication apparatus of an example 2.

FIG. 5 is a view illustrating an internal construction of the communication apparatus of an example 3.

FIG. 6 is a flowchart illustrating an operation of the communication apparatus of the example 3.

FIG. 7 is a view illustrating an internal construction of the communication apparatus of an example 4.

FIG. 8 is a flowchart illustrating an operation of the communication apparatus of the example 4.

FIG. 9 is a flowchart illustrating an operation of the communication apparatus of an example 5.

FIG. 10 is a flowchart illustrating an operation of the communication apparatus of an example 6.

FIG. 11 is a block diagram of the example 7.

FIG. 12 is a view illustrating a network configuration in an embodiment of the present invention.

FIG. 13 is a view illustrating an internal construction of the communication apparatus in the embodiment of the present invention.

FIG. 14 is a flowchart illustrating an operation of the communication apparatus in the embodiment of the present invention.

FIG. 15 is a view illustrating an example of having applied the example 1 to a specific system.

FIG. 16 is a view illustrating a network configuration in an example 8.

FIG. 17 is a schematic view relating to a protocol layer stack between a communication apparatus 10 and a PPP server 212.

FIG. 18 is a schematic view relating to a protocol layer stack between the communication apparatus 10 and a communication apparatus 12.

### DESCRIPTION OF NUMERALS

10 and 12 communication apparatuses
50 to 53, 60, and 61 wireless lines
70, 71 and 72 wire line
111, 211, 311, 411 and 412 networks
110, 210, and 310 base stations
40 and 7000 wire IF sections
41, 42, 43, 44 and 7005 input/output terminals
524 and 3008 data transmitting means
500 to 502 and 3000 to 3002 wireless IF sections
503 link controlling means
504, 900, 1100 and 3003 reconnection timing determining means
505, 903 and 3005 communication mode estimating means
901 and 3006 position measuring means
902 and 7004 wireless resource memory storage
1101 migration speed acquiring means
3004 and 7001 resource competition information sharing means
2900 resource competition information request message
2901 resource competition information response message
2902a to 2902f resource competition information notification message
4000 management server
7003 resource competition determining means
7002 resource competition information memory storage
514, 1102 and 7006 setting information memory storages

### BEST MODE FOR CARRYING OUT THE INVENTION

The embodiments of the present invention will be explained in details by making a reference to the accompanied drawings.

FIG. 12 illustrates a network configuration in the embodiment of the present invention, and a communication apparatus 10 of the present invention, which is arranged in, for example, a mobile unit such as a car and a train, is connected to a network 411 within the mobile unit and a network group 211 on the ground side. The communication apparatus 10 in this embodiment is connected to the network 211 on the ground side via a wireless line 51 and a base station 210. Additionally, in this embodiment, the explanation is made on the premise that the communication apparatus 10 is arranged in the mobile unit; however an arrangement thereof is not limited to this, and it does not have to be arranged always in the mobile unit.

Further, the communication apparatus 10 is connected to the network 411 on the mobile unit side via a wire line 70.

The wireless line 51 corresponds to a plurality of the communication modes. Herein, the so-called communication mode signifies a communication class that is comprised of a communication rate and a communication technique. For example, in a W-CDMA communication technique that is represented by FOMA, the service of which the communication rate is 64 kbps and 384 kbps is provided, and in this case, there exist two kinds of the communication modes, that is, one is the low-rate communication mode of which the communication technique is W-CDMA, and of which the communication rate is 64 kbps, and the other is the high-rate communication mode of which the communication technique is W-CDMA, and of which the communication rate is 384 kbps.

The switchover to the low-rate communication mode from the high-rate communication mode is automatically made under control of the base station 210 responding to a status of the wireless line 51 and a traffic amount in communication between the base station 210 and the communication apparatus 10. Additionally, it is assumed that the switchover to the high-rate communication mode from the low-rate communication mode is not supported, that is, the switchover to the high-rate communication mode from the low-rate communication mode is not made automatically.

The communication apparatus 10 takes a link control of making an attempt to shift to the high-rate communication mode from the communication mode used prior to disconnecting the wireless line 51 by disconnecting and reconnecting the wireless line 51. As a specific method of disconnecting and reconnecting the wireless line 51, there exists the method of disconnecting and reconnecting a line 213 by PPP that is established between the communication apparatus 10 and a PPP server 212 within the network 211.

Hereinafter, outlines of a procedure of making a connection between the communication apparatus 10 and the other communication apparatus, and a procedure of disconnecting the wireless line 51 will be described.

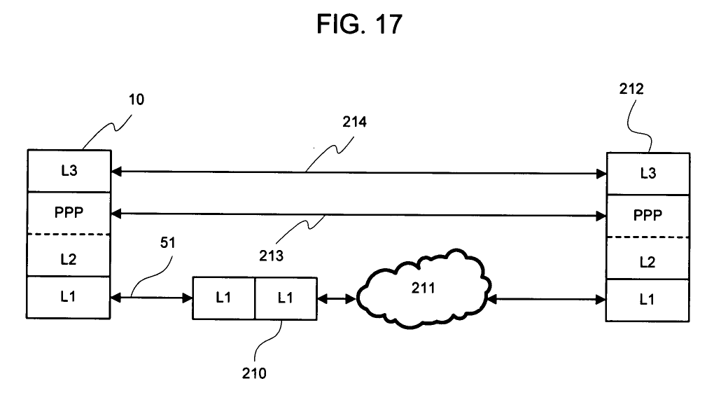

FIG. 17 is a schematic view relating to a protocol layer stack between the communication apparatus 10 and the PPP server 212.

Speaking of the procedure of making a connection between the communication apparatus 10 and the other communication apparatus, at first, a physical channel of the wireless line 51 is assigned between the communication apparatus 10 and the base station 210 with a Layer 1 (L1), and the low-rate mode or the high-rate mode is decided. Thereafter, a line 213 is established between the communication apparatus 10 and the PPP server 212 with a Layer 2 (L2). And, a line 214 of a higher Layer 3 (L3) is established, and the communication between the communication apparatus 10 and the other communication apparatus is enabled.

Next, speaking of the procedure of disconnecting the wireless line 51 for a purpose of the reconnection, originally, it is a rule to control the wireless line 51 between the communication apparatus 10 and the base station 210, thereby to re-assign the physical channel; however it is impossible to disconnect the wireless line 51 by controlling only it because the interface, which controls only the wireless line 51 between the communication apparatus 10 and the base station 210, generally, is a non-open interface.

Thereupon, disconnecting the line 213 by means of the Layer 2 (L2) between the communication apparatus 10 and the PPP server 212 allows a wireless bearer including the wireless line 51 to be opened, whereby the wireless line 51 results in being disconnected.

In such a manner, disconnecting the wireless line 51 and thereafter reconnecting it by the communication apparatus 10 side enables a transit from the low-rate mode to the high-rate mode for the wireless line 51. Additionally, in the following explanation, explanation of the line by the PPP is omitted in order to facilitate understanding, and an attention is paid to the wireless line 51 for explanation.

On the other hand, the wire line 70 is a line that corresponds to only a single communication mode, or a line that corresponds to a plurality of the communication modes, and can automatically shift not only to the low-rate communication mode from the high-rate communication mode, but also to the high-rate communication mode from the low-rate communication mode. Additionally, the wire line 70 may be a wireless line, and further it is also acceptable that it exists in plural in some cases, and it does not exist in plural in some cases.

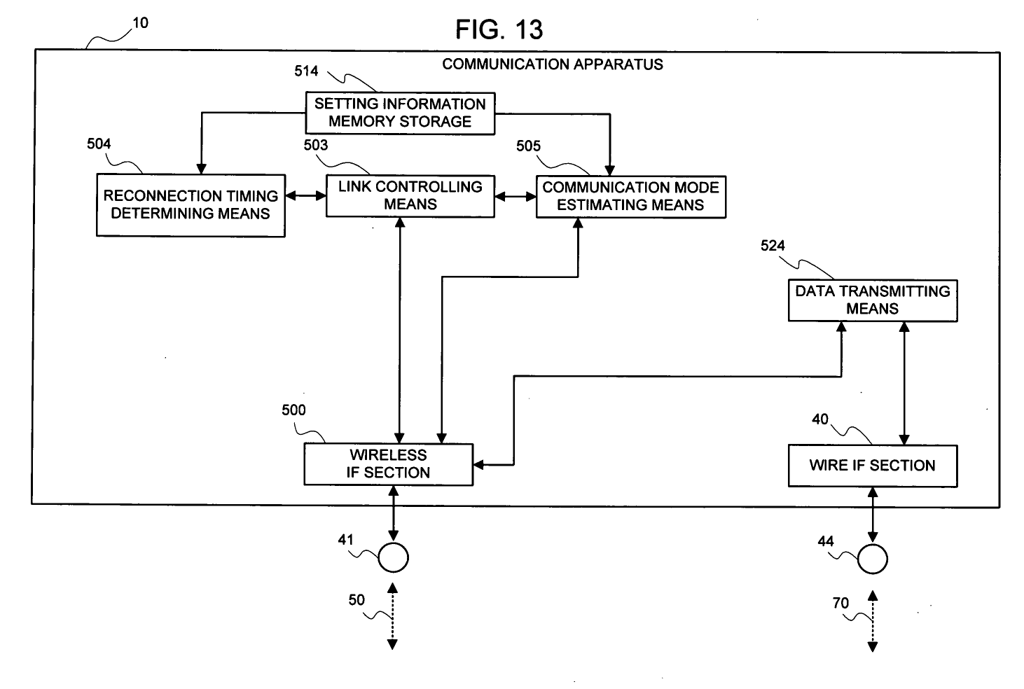

Next, the internal structure of the communication apparatus 10 in this example is shown in FIG. 13.

The communication apparatus 10 includes a link controlling means 503, a reconnection timing determining means 504, a communication mode estimating means 505 and a setting information memory storage 514 together with a wireless IF section 500, a wire IF section 40, and a data transmitting means 524. Further, each of input/output terminals 41 and 44 is an external input/output terminal with the communication apparatus 10

The wire IF section 40 has a function of making communication with the network 411 within the mobile unit by means of the wire line 70 that is established via the external input/output terminal 44. It receives data transmitted from the network 411, and outputs it to the data transmitting means 524. Further, The wire IF section 40, into which transmission data is input from the data transmitting means 524, outputs it to the network 411.

The data transmitting means 524, into which reception data is input from the wire IF section 40, outputs it as transmission data to the wireless IF section 500. It outputs the reception data input from the wireless IF section 500 as transmission data to the wire IF section 40.

The wireless IF section 500 has a function of making communication with the communication apparatus 10 and the ground. The wireless line 51 is established with the base station 210 via the input/output terminal 41. Further, the wireless IF section 500 has a function of acquiring band information of the wireless line 51 and a connection status, and a function of connecting or disconnecting the wireless line 51. Additionally, the method of calculating the communication band will not be described in details because it has no direct relation to the present invention, and for example, the method of estimating the communication band by means of a pair packet is generally known.

The wireless IF section 500 executes the input/output operation described below.

(1) It transmits data input from the data transmitting means 524 to the base station 210, and receives data transmitted from the base station 210 to output it to the data transmitting means 524.

(2) It transmits a message for requesting the connection or the disconnection of the line to the base station 210, and receives a response messages hereto.

(3) The wireless IF section 500, into which a request for notifying band information of the line and a request for notifying a connection status of the line are input from the reconnection timing determining means 504, outputs the band information and the connection/disconnection status of the line acquired respectively.

(4) The wireless IF section 500, into which a request for notifying band information of the line is input from the communication mode estimating means 505, outputs the acquired band information.

(5) The wireless IF section 500, into which an instruction for connecting/disconnecting the line is input from the link controlling means 503, outputs a response indicating a finish of the process of the connection/disconnection to the link controlling means 503.

The communication mode estimating means 505, which has a function of estimating the communication mode of the wireless IF section 500, outputs a request for notifying band information to the wireless IF section 500, and the acquired band information is input into it. And, the communication mode estimating means 505 estimates the communication mode of the wireless IF section 500 based upon this band information. An estimation result of the communication mode of the wireless IF section 500 is output to the link controlling means 503, and a response indicating a finish of the link control process is input.

The estimation of the communication mode is realized by investigating whether the communication band of the wireless IF section is within the threshold for determining the communication mode. Additionally, only in a case where the identical estimation result of the communication mode has been obtained continuously by the threshold of the number of times of the continuous determination, the communication mode is decided because the communication band dynamically fluctuates in the wireless environment. With this, a precision of the estimation result of the communication mode is enhanced. The threshold for determining the communication mode and the threshold of the number of times of the continuous determination are input from the setting information memory storage 514.

As one example of the method of estimating the communication mode, the method is specifically shown of estimating the communication mode of a downlink for the wireless IF section that corresponds to the low-rate wireless communication mode (for example, the maximum communication rate is 144 kbps) and the high-rate wireless communication mode (for example, the maximum communication rate is 2.4 Mbps). Additionally, it is difficult to directly measure the communication band of only the wireless line 51, whereby the measurement result of the communication band of the line 214 is regarded as a measurement result of the communication band of the wireless line 51.

At first, assume that the threshold for determining the communication mode is set so that in a case where the communication band of the downlink is less than 150 kbps, the communication mode is determined to be a low-rate wireless communication mode, and in a case where it is 150 kbps or more, and yet 2.4 Mbps or less, the communication mode is determined to be a high-rate wireless communication mode. Further, assume that the threshold of the number of times of the continuous determination is set so that the three-time detection result of the communication mode allows the communication mode to be decided.

In a case where the communication band obtained by continuously estimating the communication mode is 60 kbps, 100 kbps, and 90 kbps, respectively, each communication band is within a range for allowing a determination that the communication mode is a low-rate wireless communication mode to be made, and the identical estimation result has been obtained three times in succession, whereby the communication mode is decided to be a low-rate wireless communication mode.

On the other hand, in a case where the communication band is 800 kbps, 600 kbps, and 100 kbps, respectively, the communication mode remains undecided because the third estimation result demonstrates that the communication mode is a low-rate wireless communication mode even though the first and second estimation results demonstrate that the communication mode is a high-rate wireless communication mode.

The reconnection timing determining means 504 has a function of determining whether the reconnection should be performed. It outputs a request for notifying a connection status of the line to the wireless IF section 500, and an acquisition result of the connection status is input into it. Further, the reconnection timing determining means 504, into which a request for determining the reconnection timing is input from the link controlling means 503, outputs a determination result. As to the determination of the reconnection timing, in a case where the communication mode of the wireless IF section 500 estimated by the communication mode estimating means 505 is a low-rate communication mode, this timing is determined to be a timing for the reconnection. The kind of the communication mode, which can be used by the wireless IF section 500, is input from the setting information memory storage 514.

The link controlling means 503 has a function of controlling the reconnection of the line of the wireless IF section 500. The link controlling means 503, into which an estimation result of the communication mode of the wireless IF section 500 is input from the communication mode estimating means 505, outputs a response indicating a finish of the link control process to the communication mode estimating means 505. Further, the link controlling means 503 outputs the communication mode of the wireless IF section 500 estimated by the communication mode estimating means 505 to the reconnection timing determining means 504, and a determination result of the reconnection timing is input. Further it outputs an instruction for connecting/disconnecting the line to the wireless IF section 500, and a response indicating a finish of the connection/disconnection process is input into it.

The setting information memory storage 514 provides a function of pre-storing the setting information necessary for the operation. The stored information includes at least, the kind of the communication mode of the wireless IF section 500, the threshold for determining the communication mode, and the threshold of the number of times of the continuous determination.

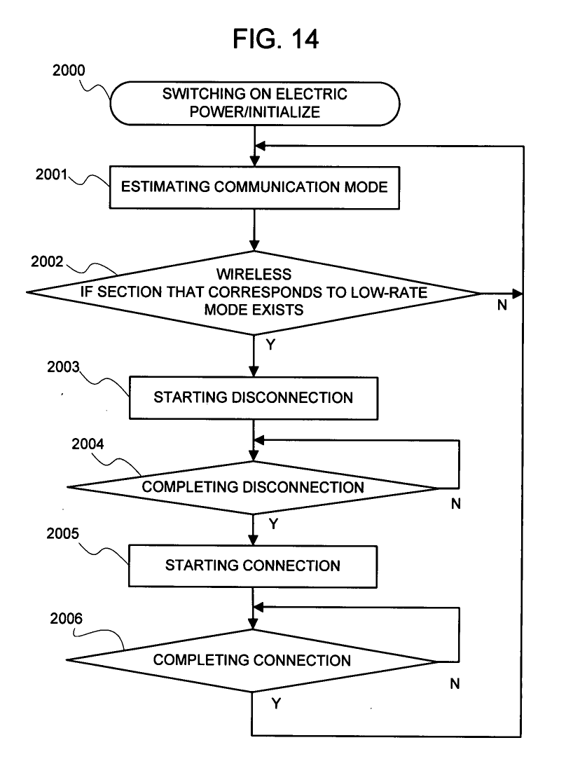

Continuously, by making a reference to FIG. 14, an operation of the communication apparatus 10 in this example is shown. Additionally, the operation shown herein is only an operation of the portion of the link control relating to the present invention, and a transmission/reception operation of user data that has no direct relation hereto is omitted.

At first, switching on the electric power of the communication apparatus 10 triggers an initialize (step 2000). Specifically, the setting information memory storage 514 outputs information of a permissible range of the deterioration in the performance due to the reconnection to the reconnection timing determining means 504, and outputs the threshold for determining the communication mode to the communication mode estimating means 505.

Continuously, the communication mode estimating means 505, into which the threshold for determining the communication mode has been input, acquires band information from the wireless IF section 500 that corresponds to a plurality of the communication modes, and estimates the communication mode of the downlink or the uplink that the wireless IF section is using (step 2001).

The link controlling means 503 requests the reconnection timing determining means 504 to determine the reconnection timing.

The reconnection timing determining means 504 collects information necessary for determining the timing. Specifically, it acquires the communication mode that the wireless IF section 500 is using. In a case where the acquired communication mode is a low-rate communication mode, the reconnection timing determining means 504 determines that this timing is a timing at which the reconnection should be performed (step 2002: Y). On the other hand, in a case where the acquired communication mode is a high-rate communication mode, the reconnection timing determining means 504 determines that this timing is a timing at which the reconnection should not be performed (step 2002: N). The determination result is output to the link controlling means 503.

If the determination result of the reconnection timing demonstrates that this timing is a timing at which the reconnection should be performed, the link controlling means 503 instructs the wireless IF section 500 to disconnect the line, and the wireless IF section 500 having received the instruction transmits a message for requesting the disconnection to the base station, and disconnects the line (step 2003).

Thereafter, the link controlling means 503 waits for a response indicating a completion of the disconnection from the wireless IF section 500 (step 2004).

If this timing is a timing at which the reconnection should not be performed, the link controlling means 503 notifies a finish of the link control process to the communication mode estimating means 505, and the operation returns to the step 2001.

Upon receipt of the response indicating a finish of the disconnection, the link controlling means 503 instructs the wireless IF section 500 having made a disconnection to connect the line. The wireless IF section 500 having received the instruction transmits a message for requesting the connection of the line to the base station, and establishes the line (step 2005).

Thereafter, the link controlling means 503 waits for a response indicating a completion of the connection from the wireless IF section 500 (step 2006). Upon receipt of the response (step 2006: Y), the link controlling means 503 outputs a notification saying a finish of the link control process to the communication mode estimating means 505, and the operation returns to the step 2001.

Additionally, it is not that a series of the processes from the step 2001 to the step 2006 is performed at any time as described above, but by setting a sleep time of the process ahead of the estimation of the communication mode in the step 2001, it may be performed periodically.

Continuously, a specific example of the communication system for which the present invention has been applied will be explained below.

### EXAMPLE 1

An example 1 of the present invention will be explained in details by making a reference to the accompanied drawings.

In the example 1, an example will be explained of having applied the present invention for the system in which the lines that corresponds to a plurality of the communication modes are combined, one logical line is configured between the transmission and the reception, and this one logical line is employed to make communication.

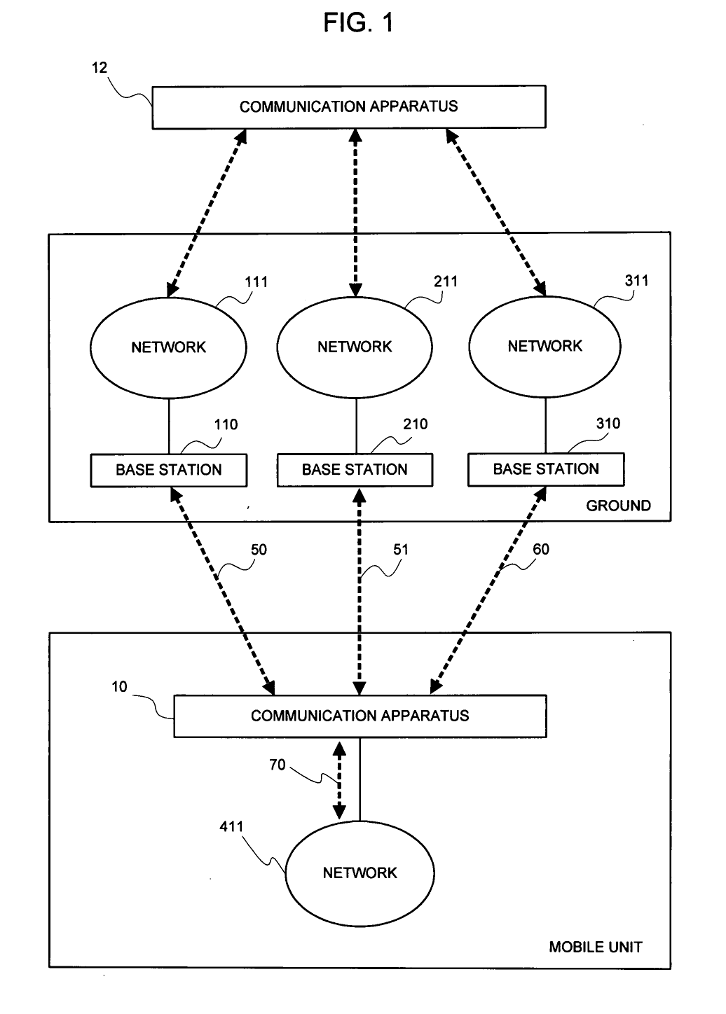

FIG. 1 illustrates a network configuration in the example 1 of the present invention, and a communication apparatus 10 of the present invention, which is arranged in the mobile unit such as a car and a train, is connected to a network 411 within the mobile unit and a network group on the ground side, and is connected to a network 111 on the ground side via a wireless line 50 and a base station 110, to a network 211 on the ground side via a wireless line 51 and a base station 210, and to a network 311 on the ground side via a wireless line 60 and a base station 310, respectively. And, the communication apparatus 10 is connected to a communication apparatus 12, being a transmission/reception destination of data of the communication apparatus 10, via the networks 111, 211, and 311. That is, the communication apparatus 10 and the communication apparatus 12 make it a rule to combine a line including the wireless line 50 (a line between the communication apparatus 10 and the communication apparatus 12 in a UDP layer), a line including the wireless line 51 (a line between the communication apparatus 10 and the communication apparatus 12 in the UDP layer), and a line including the wireless line 60 (a line between the communication apparatus 10 and the communication apparatus 12 in a UDP layer), to configure one logical line between the transmission and the reception, and to make communication by employing this logical line. Further, the communication apparatus 10 is connected to the network 411 on the mobile unit side via a wire line 70. Additionally, in this embodiment, the explanation is made on the premise that the communication apparatus 10 is arranged within the mobile unit; however an arrangement thereof is not limited to this, and it does not have to be always arranged within the mobile unit.

The wireless lines 50 and 51 constituting the logical line correspond to a plurality of the communication modes. The communication mode of the communication between each of the base stations 110 and 210 and the communication apparatus 10 is automatically switched only to the low-rate communication mode from the high-rate communication mode under control of the base stations 110 and 210. The communication apparatus 10 takes a link control of making an attempt to re-secure the high-rate communication mode by disconnecting and reconnecting these wireless lines 50 and 51. The details of this link control will be described later. Additionally, as a specific method of disconnecting and reconnecting the wireless lines 50 and 51, there exists the method of disconnecting and reconnecting the line by the PPP that is established between the communication apparatus 10 and the PPP server within the networks 111 and 211, and in order to make the following explanation easy, explanation of the line by the PPP is omitted, and an attention is paid to the wireless lines 50 and 51 for explanation.

On the other hand, each of the wireless line 60 and the wire line 70 is a line that corresponds to only a single communication mode, or a line that corresponds to a plurality of the communication modes and can shift automatically not only to the low-rate communication mode from the high-rate communication mode but also to the high-rate communication mode from the low-rate communication mode.

Additionally, in FIG. 1, each of the networks 111, 211, and 311 is a separate network; however they may be unified into one network.

Further, the wireless lines 50 is established between the base station 110 and the communication apparatus 10, and the wireless line 51 is established between the base station 210 and the communication apparatus 10; however they may be established with the identical base station, respectively.

Further, in FIG. 1, three wireless lines that connect to the base stations on the ground, respectively, are shown; however it is enough that there exists at least one wireless line that corresponds to a plurality of the communication modes, and automatically can shift only to the low-rate communication mode from the high-rate communication mode.

Further, the wire line 70 may be a wireless line, and it is also acceptable that it exists in plural in some case, and it does not exist in plural in some cases.

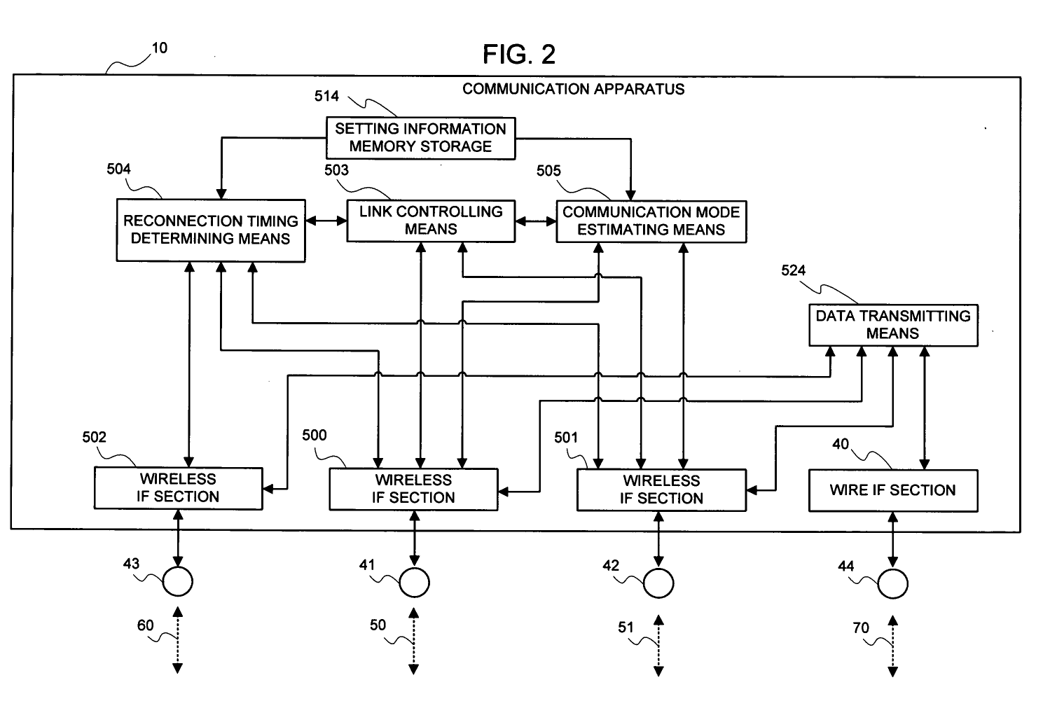

Next, the internal structure of the communication apparatus 10 in this example is shown in FIG. 2.

The communication apparatus 10 includes three wireless IF sections 500, 501, and 502, a wire IF section 40, a data transmitting means 524, a link controlling means 503, a reconnection timing determining means 504, a communication mode estimating means 505, and a setting information memory storage 514. Further, each of input/output terminals 41 to 44 is an external input/output terminal with the communication apparatus 10

Each of the wireless IF sections 500 to 502 has a function of making communication with the communication apparatus 10 and the ground. The wireless lines 50, 51, and 60 are established with the base stations 110, 210, and 310 via the input/output terminals 41 to 43, respectively. The wireless IF sections 500 to 502 have a function of acquiring band information and a connection status of the wireless lines 50, 51, and 60, respectively, and a function of connecting or disconnecting the wireless lines 50, 51, and 60, respectively.

The wireless IF sections 500 to 502 execute the input/output operation described below.

(1) They transmit data input from the data transmitting means 524 to the base stations 110, 210, and 310, and receive data transmitted from the base stations 110, 210, and 310 to output it to the data transmitting means 524.

(2) They transmit the band information and the connection status to the data transmitting means 524.

(3) They transmit a message for requesting the connection or the disconnection of the line to the base stations 110, 210, and 310, and receive a response messages hereto.

(4) The wireless IF sections 500 to 502, into which a request for notifying band information of the line and a request for notifying a connection status of the line are input from the reconnection timing determining means 504, outputs the band information and the connection/disconnection status of the line acquired respectively.

(5) Each of the wireless IF sections 500 and 501, into which a request for notifying band information of the line is input from the communication mode estimating means 505, outputs the acquired band information.

(6) Each of the wireless IF sections 500 and 501, into which an instruction for connecting/disconnecting the line is input from the link controlling means 503, outputs a response indicating a finish of the process of the connection/disconnection to the link controlling means 503.

The wire IF section 40 has a function of making communication with the network 411 within the mobile unit by means of the wire line 70 that is established via the external input/output terminal 44. It receives data transmitted from the network 411, and outputs it to the data transmitting means 524. Further, The wire IF section 40, into which transmission data is input from the data transmitting means 524, outputs it to the network 411.

The data transmitting means 524 has a function of allotting data, which the communication apparatus 10 transmits, to an appropriate wireless IF section. The data transmitting means 524, into which reception data is input from the wire IF section, outputs it to one of the wireless IF sections 500 to 502 as transmission data. Further, it outputs the reception data input from the wireless IF sections 500 to 502 to the wire IF section 40 as transmission data.

With the function of allotting the transmission data that the data transmitting means 524 has, the data has to be appropriately allotted to each of the wireless IF sections 500 to 502 so as to prevent occurrence of a load due to concentration of data being transmitted upon a specific wireless IF. As a method of allotting the transmission data, the method is thinkable of allotting the transmission data by taking the line rate or the load into consideration. One example of the method of allotting the transmission data is described in the document, Tsuneo NAKATA, et al., “Internet Access for Vehicles (2)-Flow Control”, Proceedings of the 2004 IEICE General Conference, B-5-164. Additionally, the method of allotting the transmission data is not limited hereto, and the other methods are also applicable.

The communication mode estimating means 505 has a function of estimating the communication modes of the wireless IF sections 500 and 501. It outputs a request for notifying band information to the wireless IF sections 500 and 501, and the acquired band information is input into it. And, the communication mode estimating means 505 estimates the communication modes of the wireless IF sections 500 and 501 based upon this band information, and outputs an estimation result of the communication modes of the wireless IF sections 500 and 501 to the link controlling means 503, and a response indicating a finish of the link control process is input responding hereto. Further, the threshold for determining the communication mode and the threshold of the number of times of the continuous determination are input from the setting information memory storage 514 for a purpose of estimating the communication mode.

The reconnection timing determining means 504 has a function of determining whether the reconnection should be performed. The reconnection timing determining means 504 outputs a request for notifying a connection status of the line, and a request for notifying band information to the wireless IF sections 500 to 502, and an acquisition result of the connection status and the band information is input into it. Further, the reconnection timing determining means 504, into which a request for determining the reconnection timing is input from the link controlling means 503, outputs a determination result. Further, an upper limit of the number of the wireless IF section of which the disconnection status is permissible, and a lower limit of the total value of the bands that can be utilized by the wireless IF sections other than the wireless IF section for making a reconnection are input into the reconnection timing determining means 504 as information of a permissible range of the deterioration in the performance due to the reconnection, which becomes a criterion for determining the reconnection timing, from the setting information memory storage 514.

The link controlling means 503 has a function of controlling the reconnection of the lines of the wireless IF sections 500 and 501. The link controlling means 503, into which an estimation result of the communication modes of the wireless IF sections 500 and 501 is input from the communication mode estimating means 505, outputs a response indicating a finish of the link control process to the communication mode estimating means 505. Further, the link controlling means 503 outputs a request for determining the reconnection timing including information of the reconnection-candidate wireless IF section to the reconnection timing determining means 504, and a determination result of the reconnection timing is input into it. Further, the link controlling means 503 outputs an instruction for connecting/disconnecting the line to the wireless IF sections 500 and 501, and a response indicating a finish of the connection/disconnection process is input into it.

The setting information memory storage 514 has a function of pre-storing the setting information necessary for the operation. The stored information includes at least information of a permissible range of the deterioration in the performance due to the reconnection, the threshold for determining the communication mode, and the threshold of the number of times of the continuous determination. The information of a permissible range of the deterioration in the performance due to the reconnection is output to the reconnection timing determining means 504, and the threshold for determining the communication mode and the threshold of the number of times of the continuous determination are output to the communication mode estimating means 505.

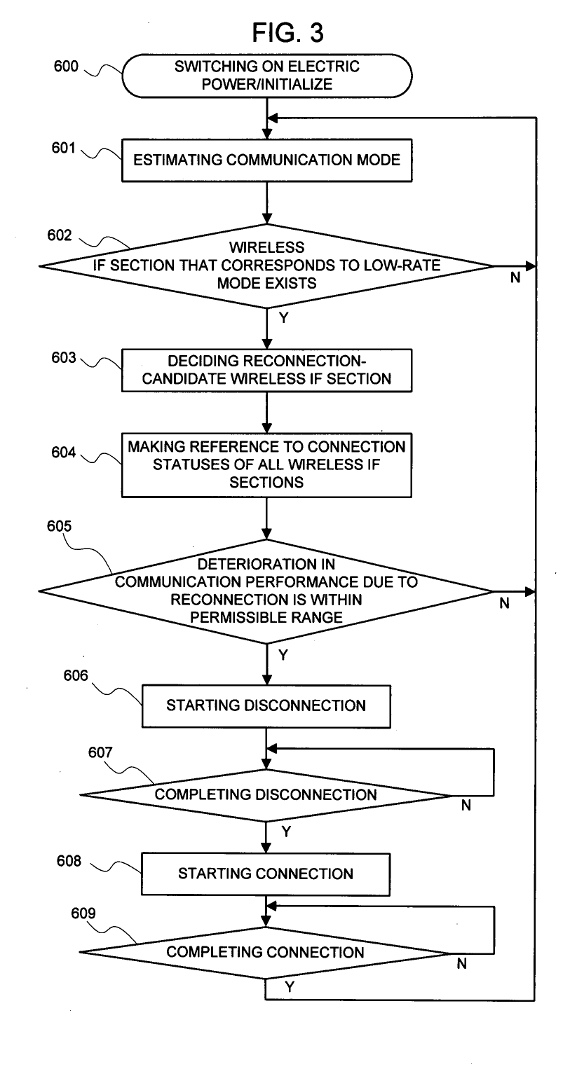

Continuously, by making a reference to FIG. 3, an operation of the communication apparatus 10 in this example is shown. Additionally, the operation shown herein is only an operation of the portion of the link control relating to the present invention, and a transmission/reception operation of user data that has no direct relation hereto is omitted.

At first, switching on the electric power of the communication apparatus 10 triggers an initialize (step 600). Specifically, the setting information memory storage 514 outputs information of a permissible range of the deterioration in the performance due to the reconnection to the reconnection timing determining means 504, and outputs the threshold for determining the communication mode and the threshold of the number of times of the continuous determination to the communication mode estimating means 505.

Continuously, the communication mode estimating means 505, into which the threshold for determining the communication mode has been input, acquires band information from the wireless IF sections 500 and 501 that correspond to a plurality of the communication modes, and estimates the communication mode of the downlink or the uplink that each wireless IF section is using (step 601). This estimation of the communication mode is realized by investigating whether the communication band of each wireless IF section is within the threshold for determining the communication mode. Additionally, only in a case where the identical estimation result of the communication mode has been obtained continuously by the threshold of the number of times of the continuous determination, the communication mode is decided because the communication band fluctuates dynamically in the wireless environment. With this, a precision of the estimation result of the communication mode is enhanced.

As one example of the method of estimating the communication mode, the method is specifically shown of estimating the communication mode of the downlink for the wireless IF section that corresponds to the low-rate wireless communication mode (for example, the maximum communication rate is 144 kbps) and the high-rate wireless communication mode (for example, the maximum communication rate is 2.4 Mbps).

At first, assume that the threshold for determining the communication mode is set so that if the communication band of the downlink is less than 150 kbps, the communication mode is determined to be a low-rate wireless communication mode, and if it is 150 kbps or more and yet 2.4 Mbps or less, the communication mode is determined to be a high-rate wireless communication mode. Further, assume that the threshold of the number of times of the continuous determination is set so that the three-time detection result of the communication mode allows the communication mode to be decided.

In a case where the communication band obtained by continuously estimating the communication mode is 60 kbps, 100 kbps, and 90 kbps, respectively, each communication band is within a range for allowing a determination that the communication mode is a low-rate wireless communication mode to be made, and the identical estimation result has been obtained three times in succession, whereby the communication mode is decided to be a low-rate wireless communication mode.

On the other hand, in a case where the communication band is 800 kbps, 600 kbps, and 100 kbps, respectively, the communication mode remains undecided because the third estimation result demonstrates that the communication mode is a low-rate wireless communication mode even though the first and second estimation results demonstrate that the communication mode is a high-rate wireless communication mode.

Additionally, it is not that the communication modes of all of the wireless IF sections correspondent to a plurality of the communication modes are estimated simultaneously, but the communication modes may be sequentially estimated wireless system by wireless system. Specifically, it is thinkable that after the communication mode of a WCDMA-correspondence wireless IF section is estimated, the process after a step 602 to be later described is performed, and next, the similar process is performed for a cdma2000-correspondence wireless IF section.

The method of calculating the communication band of each wireless IF section will not be described in details because it has no direct relation to the present information, and for example, the method of estimating the communication band by means of a pair packet is generally known.

Continuously, the link controlling means 503 confirms whether there exists the wireless IF section that correspondents to the low-rate communication mode (step 602), and in a case where there exists the wireless IF section that correspondents to the low-rate communication mode (step 602: Y), it assumes that the corresponding wireless IF section is a reconnection-candidate wireless IF section (step 603). In a case where there exists a plurality of the wireless IF sections that correspond to the low-rate communication mode, the wireless IF section having a highest effect of enlarging the band owing to transiting to the high-rate communication mode, out of these wireless IF sections, becomes a reconnection-object wireless IF section. Specifically, it selects the wireless IF section in the order of the wireless IF section of which both of the downlink and the uplink correspond to a low-rate communication mode, the wireless IF section of which only the downlink corresponds to a low-rate communication mode, and the wireless IF section of which only the uplink corresponds to a low-rate communication mode. In a case where there exists a plurality of the wireless IF sections each having an identical effect of enlarging the band (for example, in a case where there exists a plurality of the wireless IF sections of which both of the downlink and the uplink correspond to a low-rate communication mode), anyone of these wireless IF sections may be selected.

On the other hand, in a case where there exists no wireless IF section that corresponds to the low-rate communication mode (step 602: N), the link controlling means 503 outputs a notification saying a finish of the link control process to the communication mode estimating means 505, which re-estimates the communication mode (step 601).

The link controlling means 503 requests the reconnection timing determining means 504 to determine the reconnection timing in succession to deciding the reconnection-candidate wireless IF section.

The reconnection timing determining means 504 collects information necessary for determining the timing (step 604). Specifically, it acquires a connection status of the line and band information from the wireless IF sections 500 to 502.

In a case where the acquired connection status and band information demonstrate that the deterioration in the communication performance due to the reconnection of the line is within a permissible range, the reconnection timing determining means 504 determines that this timing is a timing at which the reconnection should be performed (step 605: Y). On the other hand, in a case where the deterioration in the communication performance exceeds a permissible range, the reconnection timing determining means 504 determines that this is a timing at which the reconnection should not be performed (step 605: N). A determination result is output to the link controlling means 503.

The details of the determination method in which the degree of the deterioration in the communication performance due to the reconnection is assumed to be a criterion are as follows.

At first, the reconnection timing determining means 504 checks whether the number of the wireless IF sections in a disconnection status is equal to or less than the threshold from the connection status of the line. Next, it checks whether the total value of the bands of the wireless IF sections other than the reconnection-candidate wireless IF section is equal to or more than the threshold from the band information. Finally, the reconnection timing determining means 504 implements a logical product operation for these two check results, and in a case where both of the operation results satisfy the determination criterion, it determines that the deterioration in the communication performance due to the reconnection of the line is within a permissible range. Additionally, This method of the final determination may be a method of implementing not a logical product operation but a logical sum operation.

If the determination result of the reconnection timing demonstrates that this timing is a timing at which the reconnection should be performed, the link controlling means 503 instructs the reconnection-candidate wireless IF section to disconnect the line, and the wireless IF section having received the instruction transmits a message for requesting the disconnection to the base station, and disconnects the line (step 606).

If this timing is a timing at which the reconnection should not be performed, the link controlling means 503 notifies a finish of the link control process to the communication mode estimating means 505, and the operation returns to the step 601.

Thereafter, the link controlling means 503 waits for a response indicating a finish of the disconnection from the reconnection-candidate wireless IF section (Step 607).

Upon receipt of the response indicating a finish of the disconnection, the link controlling means 503 gives an instruction for the connection to the wireless IF section that has performed the disconnection. The wireless IF section having received the instruction transmits a message for requesting the connection of the line to the base station, and establishes the line (Step 608).

Thereafter, the link controlling means 503 waits for a response indicating a finish of the connection from the wireless IF section (step 609). Upon receipt of the response (step 609: Y), the link controlling means 503 outputs a notification saying a finish of the link control process to the communication mode estimating means 505, and the operation returns to the step 601.

Additionally, it is not that a series of the processes from the step 601 to the step 609 is performed at any time as described above, but by setting a sleep time of the process ahead of the estimation of the communication mode in the step 601, it may be performed periodically.

Further, in this example, both of the connection status and the band information are employed as information for determining the reconnection timing; however only one of them may be employed. In this case, the function, the input/output, and the processing step relating to the determination information that is not used are not necessitated.

Next, a specific example of this foregoing example 1 will be explained.

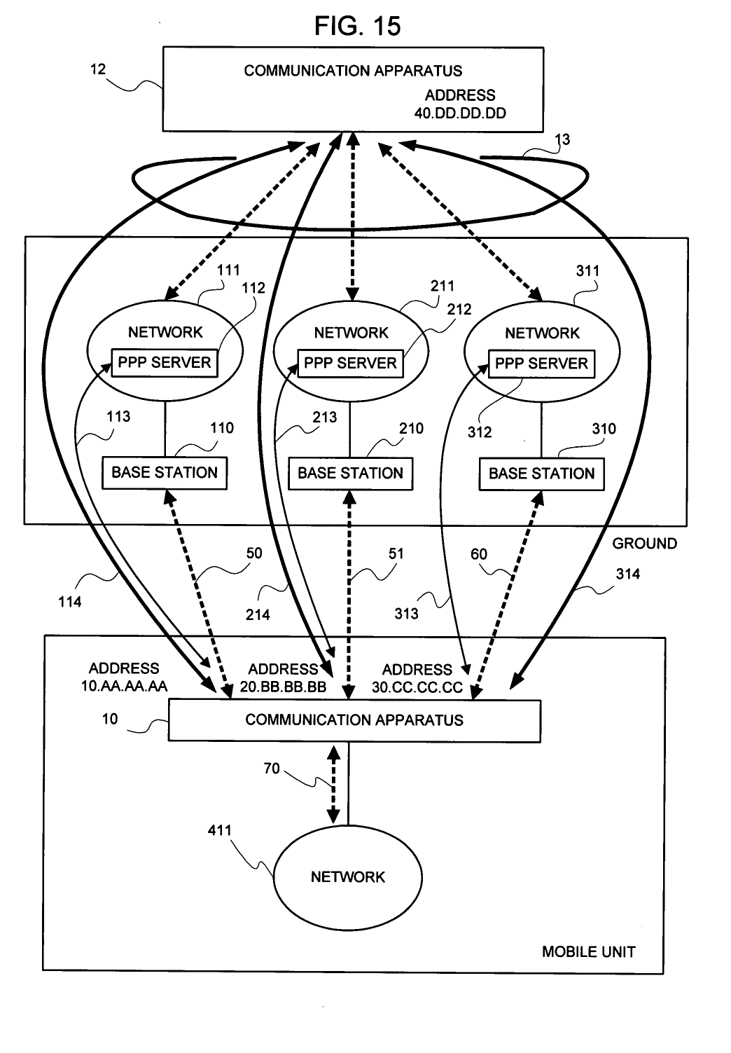

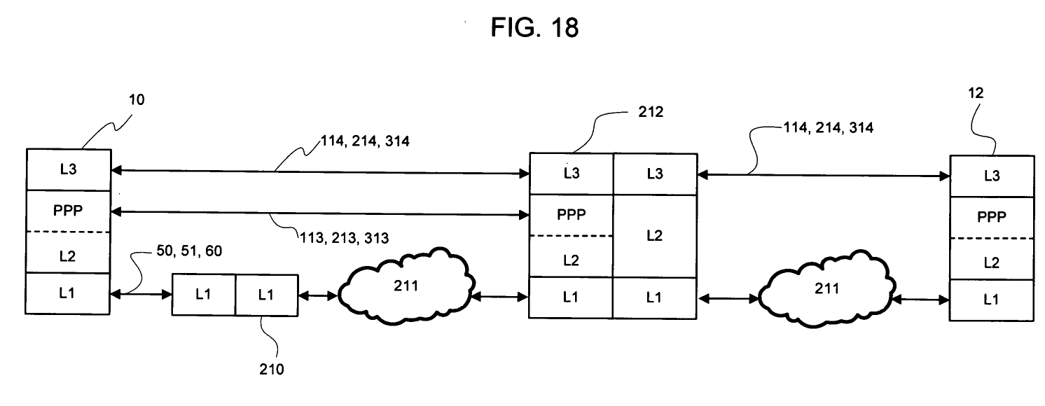

FIG. 15 is a view illustrating an example of having applied the example 1 to the specific system, and FIG. 18 is a schematic view relating to a protocol layer stack between the communication apparatus 10 and the communication apparatus 12. Additionally, in the following explanation, the case will be explained of having applied the present invention in the event of making communication via one logical line obtained by combining a plurality of the lines between the communication apparatus 10 and the communication apparatus 12. And, assume that each of the wireless IF sections 500 to 502 corresponds to the low-rate wireless communication mode of which the highest communication rate is 144 kbps, and the high-rate wireless communication mode of which the highest communication rate is 2.4 Mbps, and assume that each of the wireless IF section 500 and 501 automatically can shift only to the low-rate wireless communication mode from the high-rate wireless communication mode under control of the base station, and the wireless IF section 502 automatically can shift not only to the low-rate wireless communication mode from the high-rate wireless communication mode but also to the high-rate wireless communication mode from the low-rate wireless communication mode. Further, it is assumed that the threshold of the number of the wireless IF sections in a disconnection status is 1 (one), and the threshold of the total value of the bands of the wireless IF sections other than the reconnection-candidate wireless IF section is 900 kbps. Further, in the following example, it is assumed that the threshold for determining that the communication mode is a low-rate communication mode is 70 kbps.

At first, the physical channels of the wireless lines 50, 51, 60 are assigned between the communication apparatus 10 and the base stations 110, 210, and 310 by means of the Layer 1 (L1), respectively, and the low-rate mode or the high-rate mode is decided. Thereafter, the communication apparatus 10 establishes lines 113, 213, and 313 by the PPP by means of the Layer 2 (L2) with PPP servers 112, 212, and 312, being a line provider of the wireless lines 50, 51, 60, respectively, and acquires IP addresses.

Herein, assume that an address 10.AA.AA.AA is assigned to the wireless IF section 500 of the line 113, an address 20.BB.BB.BB to the wireless IF section 501 of the line 213, an address 30.CC.CC.CC to the wireless IF section 502 of the line 313, and an address 40.DD.DD.DD to the wireless IF section of the communication apparatus 12, respectively. And, communication is made between the communication apparatus 10 and the communication apparatus 12 by employing a single logical line 13 obtained by combining a line 114 including the line 113 in the UDP Layer (L3), a line 214 (L3) in the UDP Layer including the line 213, and a line 314 (L3) in the UDP Layer including the line 313.

In this example, in the status described above, the link controlling means 503 confirms whether the wireless IF section that corresponds to the low-rate communication mode exists, in a case where the wireless IF section that corresponds to the low-rate communication mode exists, it requests the reconnection timing determining means 504 to determine the reconnection timing. The reconnection timing determining means 504 acquires a connection status of the line and band information necessary for determining the timing from the wireless IF sections 500 to 502.

When it is determined by the link controlling means 503 that the communication mode of the wireless IF section 500 (line 50) is a low-rate communication mode, the reconnection timing determining means 504 acquires the connection status of the line and the band information necessary for determining the timing from the wireless IF sections 500 to 502.

Herein, assume that the acquired connection status of the line indicates that all of the lines are under connection, and that the band information of the wireless IF section 500 (line 50) indicates 60 kbps, the band information of the wireless IF section 501 (line 51) indicates 700 kbps, and the band information of the wireless IF section 502 (line 60) indicates 900 kbps. Then, it follows that the number of the wireless IF section in a disconnection state is equal to or less than the threshold (=1) because it is 0 (zero), and the total value of the bands of the wireless IF sections other than the wireless IF section 500, being a reconnection-candidate wireless IF section, is equal to or more than the threshold because it is 1600 kbps.

Thus, the reconnection timing determining means 504 determines that the deterioration in the communication performance due to the reconnection is within a permissible range because each result satisfies the determination criterion, and the communication apparatus 10 disconnects the line 113 (L2) between the communication apparatus 10 and the PPP server 112, and disconnects the wireless line 50 (L1) of which the band value falls below the threshold 70 kbps that allows a determination that the communication mode is of low-rate to be made. And, the communication apparatus 10 establishes the wireless line 50 (L1) by re-establishing the line 113 (L2) with the PPP server 112. During this time, even though communication cannot be made in the line 114 (L3) in the UDP layer including the wireless line 50 and the line 113, there is no possibility that communication cannot be made in the logical single line 13 because the line 214 (L3) in the UDP layer including the line 213, and the line 314 (L3) in the UDP layer including the line 313 have been established, which enables communication between the communication apparatus 10 and the communication apparatus 12.

### EXAMPLE 2

Next, an example 2 of the present invention will be explained.

In the example 2 of the present invention, the wireless IF sections 500 and 501 of the communication apparatus 10 shown in FIG. 2 of the example 1 acquire a reception quality of a radio wave, and the reconnection timing is determined by employing its result. Hereinafter, only the portion in which the example 2 differs from the example 1 will be explained.

A network configuration in this example 2 is identical to that of the example 1 shown in FIG. 2, so its explanation is omitted herein.

An internal structure of the communication apparatus 10 in the example 2, and the portion in which the example 2 differs from the example 1 will be described below.

At first, a function of acquiring the reception quality of the radio wave has been added to the wireless IF sections 500 to 502.

A configuration is made so that the reconnection timing determining means 504 outputs a request for acquiring the reception quality of the radio wave to the wireless IF sections 500 to 502, and the wireless IF sections 500 to 502 return an acquisition result.

The reconnection timing determining means 504 is configured to determine the reconnection timing by employing the acquisition result of the reception quality of the radio wave by the wireless IF sections 500 to 502 in addition to the configuration of the example 1.

The setting information memory storage 514 has a function of storing the threshold for determining the reception quality of the radio wave in addition to the configuration of the example 1. This threshold for determining the reception quality of the radio wave, which has been pre-input into the setting information memory storage 514, is output to the reconnection timing determining means 504.

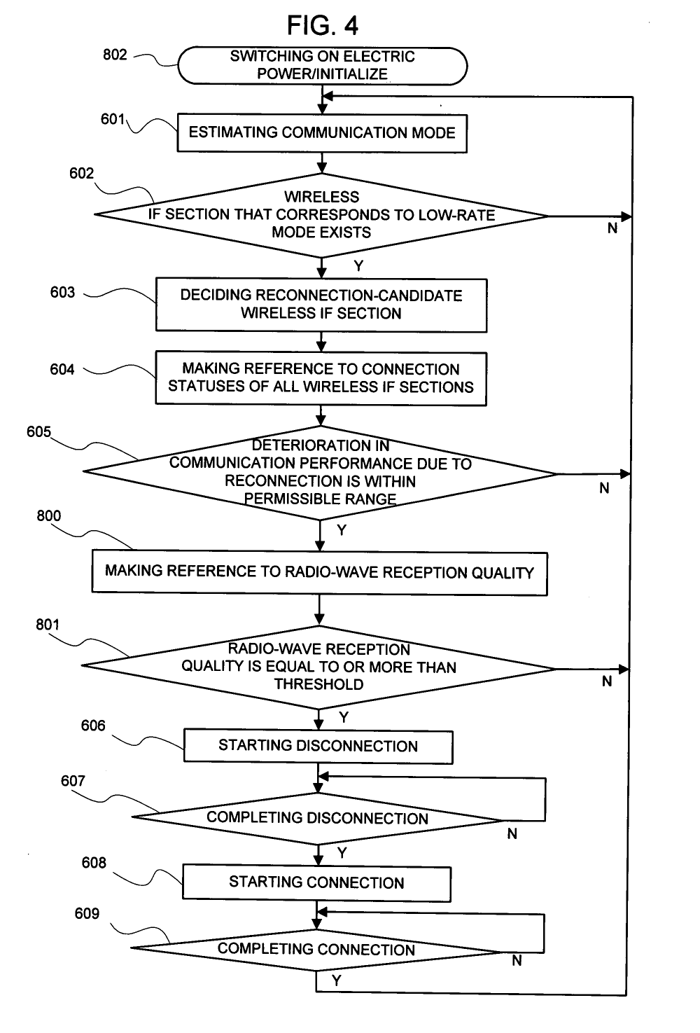

Next, an operation of the communication apparatus 10 in this example will be explained by making a reference to FIG. 4. Additionally, steps 601 to 609 are identical to that of the example 1, so its explanation is omitted herein.

In this example, in an initialize of a step 802, setting information memory storage 514 outputs the threshold for determining the reception quality of the radio wave to the reconnection timing determining means 504 in addition to the process in the step 600 of the initialize of the example 1.

Further, in this example, after the reconnection timing determining means 504 investigates whether the deterioration in the communication performance due to the reconnection is within a permissible range, it acquires the reception quality of the radio wave from the wireless IF sections 500 and 501 (step 800) if it is within a permissible range (step 605: Y). Additionally, the reception quality of the radio wave being acquired is a reception quality of the radio wave of the wireless system identical to the wireless system that uses the high-rate communication mode of the reconnection-candidate wireless IF section (it may be a value acquired by the reconnection-candidate wireless IF section itself).

Thereafter, the reconnection timing determining means 504 determines that this timing is a timing at which the reconnection-candidate wireless IF section should perform the reconnection if the acquisition result demonstrates that the reception quality of the radio wave is equal to or more than the determination threshold. On the other hand, the reconnection timing determining means 504 determines that this timing is a timing at which the reconnection-candidate wireless IF section should not perform the reconnection if the acquisition result demonstrates that the reception quality of the radio wave is less than the determination threshold (step 801).

As mentioned above, this example makes it possible to curtail a communication interruption time due to the unnecessary reconnection. The reason is that the reconnection is performed only in a status where the reception quality of the radio wave of the system that corresponds to the high-rate communication mode is equal to or more than the threshold, and yet the possibility that the high-rate communication mode can be secured within a cover area is high.

Additionally, in this example, the reception quality of the radio wave and the investigation result as to whether the deterioration in the communication performance due to the reconnection is within a permissible range are employed for the determination of the reconnection timing. The extent of the deterioration in the communication performance due to the reconnection, out of these, may not be employed for the determination of the reconnection timing. In this case, it is self-evident that the relating means and steps are omitted.

### EXAMPLE 3

Next, an example 3 of the present invention will be explained.

In the example 3 of the present invention, the communication apparatus 10 shown in FIG. 2 of the example 1 acquires a current position, and determines the reconnection timing responding to wireless resource information at a pre-recorded position. Hereinafter, the portion in which the example 3 differs from the example 1 will be explained in details.

A network configuration in this example is identical to that of the example 1 shown in FIG. 2, so its explanation is omitted herein.

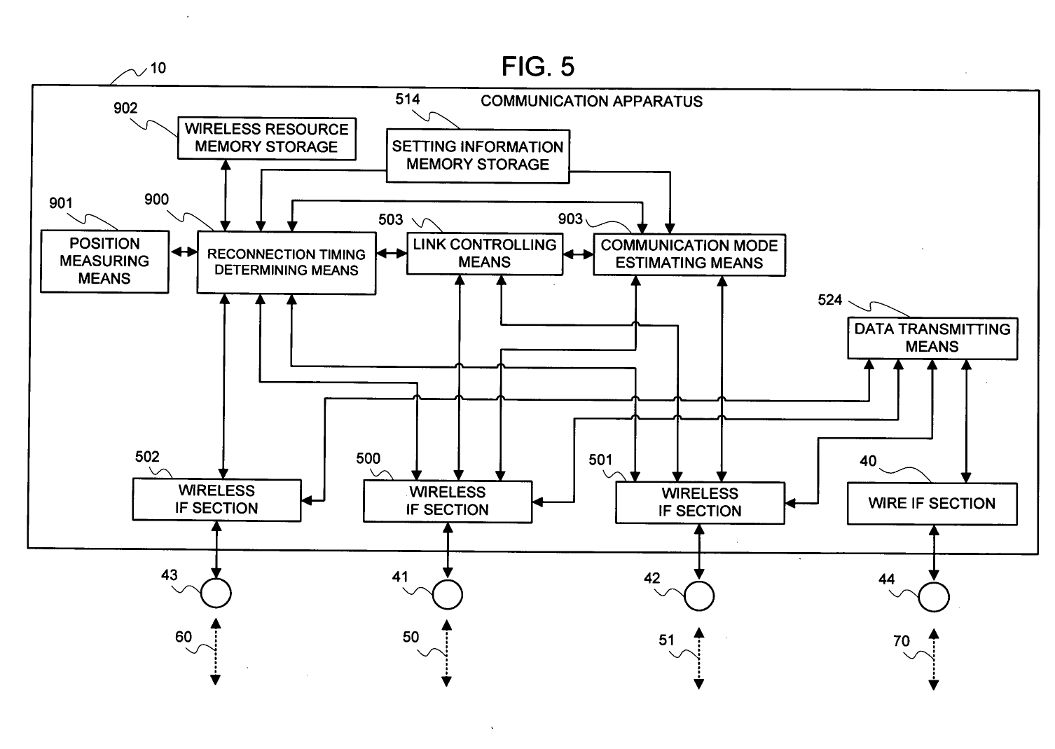

An internal structure of the communication apparatus 10 of this example is shown in FIG. 5.

A position measuring means 901, a resource information memory storage 902, a reconnection timing determining means 900, and a communication mode estimating means 903 are newly added to the communication apparatus 10 of this example, and the other portion has a configuration identical to that of the example 1, so its, explanation is omitted herein.

The position measuring means 901 has a function of acquiring a current position of the communication apparatus 10. This position measuring means 901 outputs the acquired current position responding to an input for requesting a notification of the current position from the reconnection timing determining means 900. For example, in a case of a GPS (Global Positioning System) function, or in a case where the path along which the communication apparatus 10 migrates has been decided like the case of the train, the function of acquiring the current position is realized with its information and accelerometer.

The resource information memory storage 902 stores a wireless resource amount. As a specific example of this stored wireless resource amount, a positional coordinate or a landmark such as a station on a map, and the upper limit of the number of the lines, in which the high-rate mode can be secured simultaneously, at its position are pre-stored wireless system by wireless system. And, the resource information memory storage 902 outputs the stored resource information (the upper limit of the number of the high-rate mode lines that can be secured at the current position) responding to an input for requesting a notification of the resource information (including the class of the wireless system requesting a current position and a notification, which uses the high-rate mode) from the reconnection timing determining means 900.

The reconnection timing determining means 900 has a function of determining whether this timing is a timing at which the reconnection should be performed by employing the current position of the communication apparatus 10, the resource information, and the estimation result of the communication mode in addition to the configuration of the example 1. The reconnection timing determining means 900 outputs a request for notifying a position to the position measuring means 901, and an acquisition result of the position is input into it. Further, it outputs a request for notifying resource information to the wireless resource information memory storage 902, and the corresponding resource information is input into it. Further, it outputs a request for notifying an estimation result of the communication mode to the communication mode estimating means 903, and the estimation result of the communication mode is input into it as a response.

The communication mode estimating means 903 outputs an estimation result of the communication mode responding to an input for requesting a notification of an estimation result of the communication mode from the reconnection timing determining means 900 in addition to the configuration of the example 1.

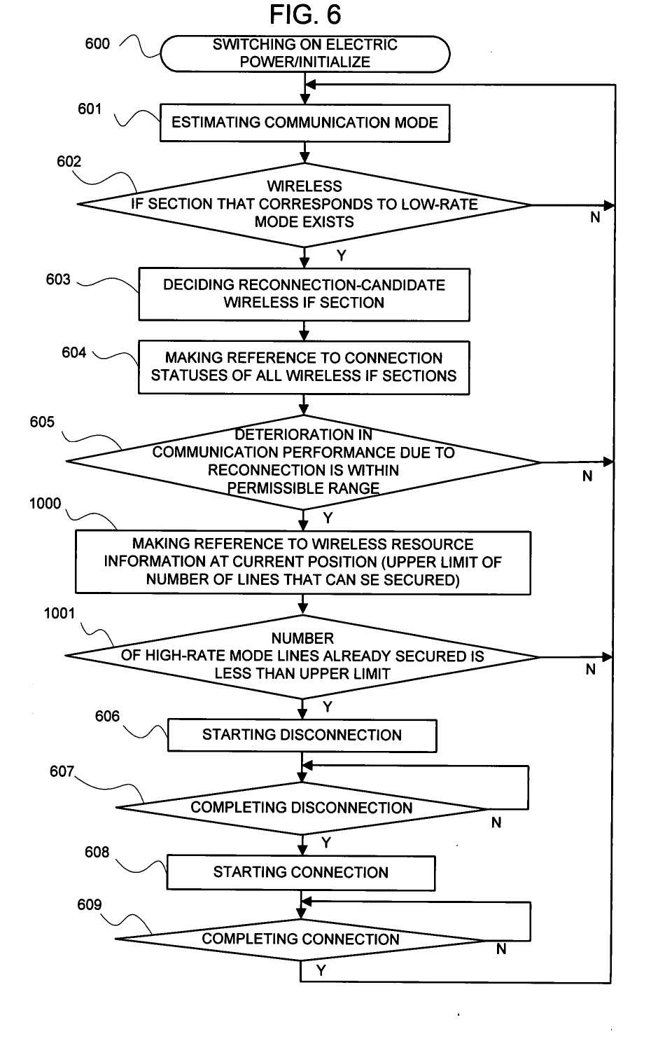

Next, an operation of the communication apparatus 10 in this example will be explained by making a reference to FIG. 6.

In FIG. 6, step 600 to step 609 are identical to that of the example 1, so its explanation is omitted herein.

In this example, after the reconnection timing determining means 900 has determined that the deterioration in the communication performance due to the reconnection is within a permissible range (step 605: Y), it acquires the current position of the communication apparatus 10 from the position measuring means 901. Thereafter, it acquires wireless resource information (the upper limit of the number of the lines, in which the high-rate mode can be secured, in the wireless system to which the reconnection-candidate wireless IF section corresponds) at the stored current position from the wireless resource memory storage 902, and an estimation result of the communication mode from the communication mode estimating means 903, respectively (step 1000).

The reconnection timing determining means 900 calculates the number of the lines of the wireless system identical to the high-rate mode of the reconnection-candidate wireless IF section from the estimation result of the communication mode, which has already been secured within the communication apparatus 10, and compares it with the upper limit obtained in the step 1000 (step 1001). As a result, if the number of the already-secured high-rate mode lines is less than the upper limit, the reconnection timing determining means 900 determines that this timing is a timing at which the reconnection should be performed (step 1001: Y).

Hereafter, the processes of the step 606 to step 609 are executed. Contrarily, if the number of the already-secured high-rate mode lines has reached the upper limit (step 1001: N), the reconnection is not performed, and the operation shifts to the step 601.

As mentioned above, this example makes it possible to curtail a communication interruption time due to the unnecessary reconnection. The reason is that the reconnection is performed only in a status where the number of the high-rate communication mode lines already secured in the IF that the communication apparatus includes is less than the upper limit of the number of the lines that can be secured at the current position of the communication apparatus, and yet the possibility that the high-rate communication mode can be secured is high.

Additionally, in this example, the position, the resource information, the estimation result of the communication mode, and the investigation result as to whether the deterioration in the communication performance due to the reconnection is within a permissible range are employed for the determination of the reconnection timing; however The extent of the deterioration in the communication performance due to the reconnection may not be employed for the determination of the reconnection timing. In this case, it is self-evident that the relating means and steps are omitted.

### EXAMPLE 4

Next, an example 4 of the present invention will be explained.

In the example 4 of the present invention, the communication apparatus 10 of FIG. 2 of the example 1 acquires a current migrating speed, and determines the reconnection timing based upon its result. Hereinafter, the portion in which the example 4 differs from the example 1 will be explained.

A network configuration in this example is identical to that of the example 1 shown in FIG. 2, so its explanation is omitted herein.

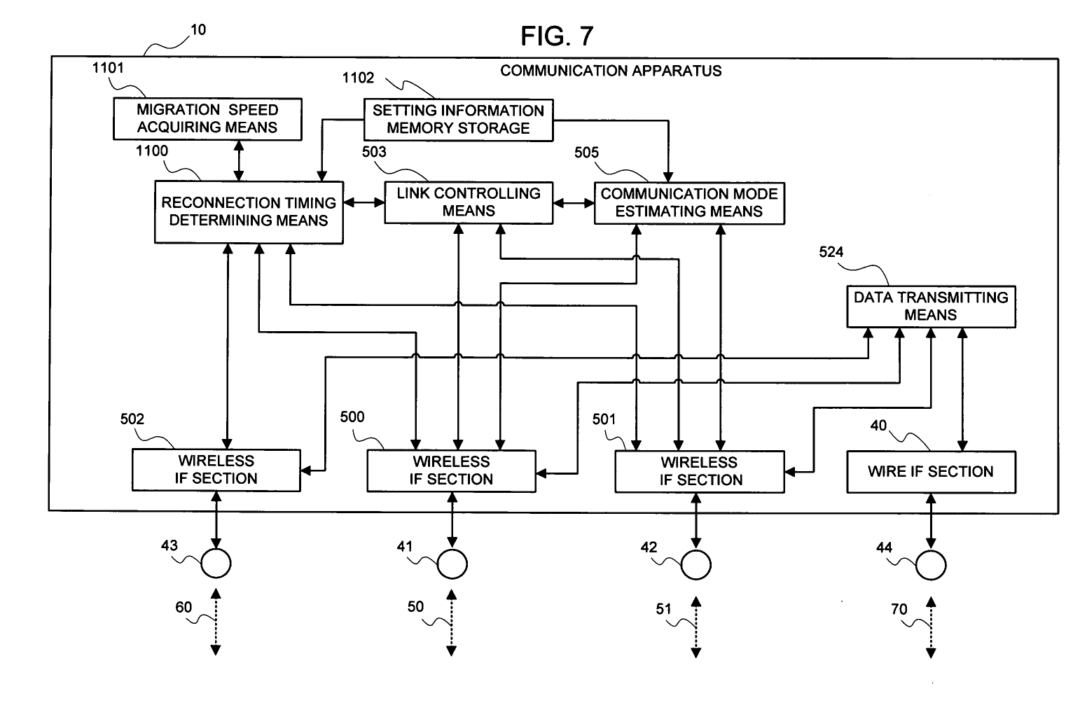

An internal structure of the communication apparatus 10 of this example is shown in FIG. 7.

The components other than a migration speed acquiring means 1101, a reconnection timing determining means 1100, and a setting information memory storage 1102 are identical that of the example 1, so its explanation is omitted herein.

The migration speed acquiring means 1101 provides a function of acquiring a current migration speed of the communication apparatus 10. The acquired result is output responding to an input for requesting a notification of the migration speed from the reconnection timing determining means 1100. Additionally, the migration speed is obtained with a time differential calculus of a position, or a time integral calculus of acceleration, whereby this means is realized with the GPS or the accelerometer similarly to the position measuring means of FIG. 5 of the example 3.

The reconnection timing determining means 1100 provides a function of determining the timing at which the reconnection should be performed by employing the migration speed of the communication apparatus 10 in addition to the function shown in example 1. It outputs a request for notifying the migration speed to the migration speed acquiring means 1101, and a response including the migration speed is input into it. Further, the threshold for determining the migration speed is input into it from the setting information memory storage 1102.

The setting information memory storage 1102 provides a function of storing the threshold for determining migration speed in determining the reconnection timing in addition to the configuration shown in example 1. This threshold for determining the migration speed, which has been pre-stored in to the setting information memory storage 1102, is output to the reconnection timing determining means 1100.

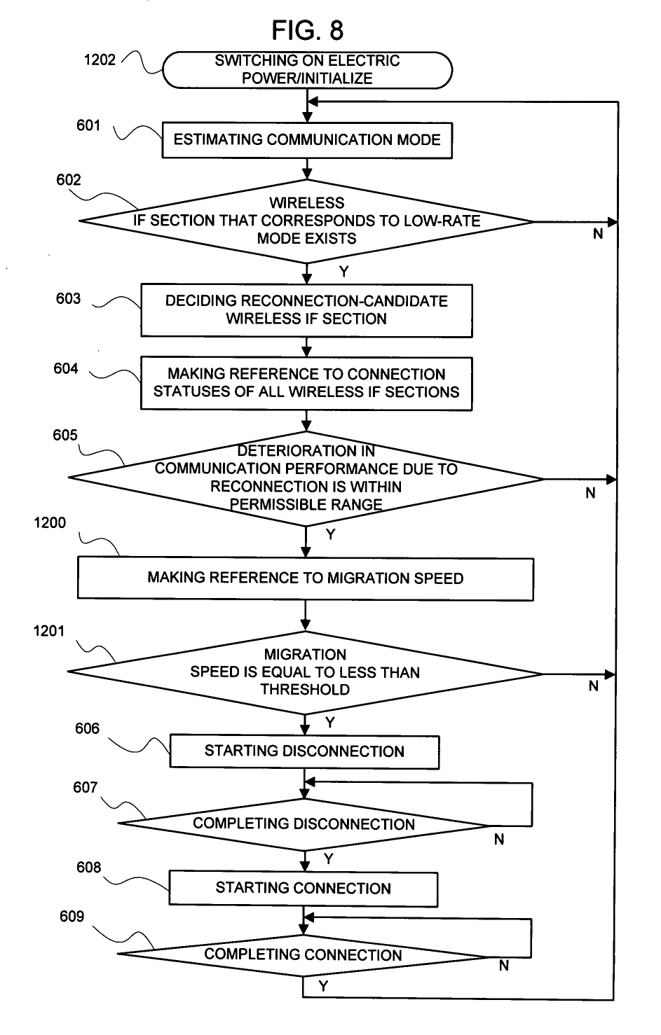

Next, an operation of the communication apparatus 10 in this example will be explained by making a reference to FIG. 8.

In FIG. 8, step 601 to step 609 are identical to that of the example 1, so its explanation is omitted herein.

In this example, in an initialize of a step 1202, the setting information memory storage 1102 outputs the threshold for determining the migration speed to the reconnection timing determining means 1101 in addition to the process in the step 600 of the initialize of the example 1.

Further, in this example, after the reconnection timing determining means 1100 has determined that the number of the wireless IF section in a disconnection status is equal to or less than the threshold (step 605: Y), it acquires the current migration speed of the communication apparatus 10 from the migration speed acquiring means 1101 (step 1200).

If the acquired migration speed is equal to or less than the determination threshold, the reconnection timing determining means 1100 considers that the deterioration in the line quality due to an increase in the migration speed is small, and yet the probability that the high-rate mode can secured is high, and determines that this timing is a timing at which the reconnection should be performed (step 1201: Y).

Hereafter, the processes of the step 606 to the step 609 are sequentially executed. Contrarily, if the migration speed is larger than the determination threshold, the reconnection timing determining means 1100 determines that this timing is a timing at which the reconnection should not be performed (step 1201: N) and the operation returns to the step 601.

As mentioned above, this example makes it possible to curtail a communication interruption time due to the unnecessary reconnection. The reason is that the reconnection is performed only in a status where the migration speed of the communication apparatus is equal to or less than the threshold, the deterioration in the line quality accompanied by the migration is small, and yet the possibility that the high-rate communication mode can be secured is high.

Additionally, in this example, the migration speed, and the investigation result as to whether the deterioration in the communication performance due to the reconnection is within a permissible range are employed for determining the reconnection timing; however it is also possible not to use the extent of the deterioration in the communication performance due to the reconnection for determining the reconnection timing. In this case, it is self-evident that the relating means and steps are omitted.

### EXAMPLE 5

An example 5 of the present invention will be explained.

In the example 5 of the present invention, the communication apparatus 10 of FIG. 2 of the example 1 acquires a transmission/reception rate of the wireless IF sections 500 and 501, which is employed for determining the reconnection timing. Hereinafter, the portion in which the example 5 differs from the example 1 will be explained. Additionally, a network configuration in this example is identical to that of the example 1 shown in FIG. 2, so its explanation is omitted herein.

A configuration of the communication apparatus 10 differs from that of the foregoing examples in the following points.

At first, a function of acquiring a transmission/reception rate per hour and storing its value for a constant time is added to the wireless IF sections 500 and 501.

The reconnection timing determining means 504 outputs a request for acquiring the transmission/reception rate including an acquisition time to the wireless IF sections 500 and 501, which return an acquisition result of the transmission/reception rate of the requested time.

The reconnection timing determining means 504 determines the reconnection timing by employing the transmission/reception rate of the wireless IF sections 500 and 501 in addition to the configuration of the example 1.

The setting information memory storage 514 provides a function of storing the threshold for determining the transmission/reception rate and the determination time in determining the reconnection timing in addition to the configuration of the example 1. These threshold for determining the transmission/reception rate and determination time, which have been pre-stored into the setting information memory storage 514, are output to the reconnection timing determining means 504.

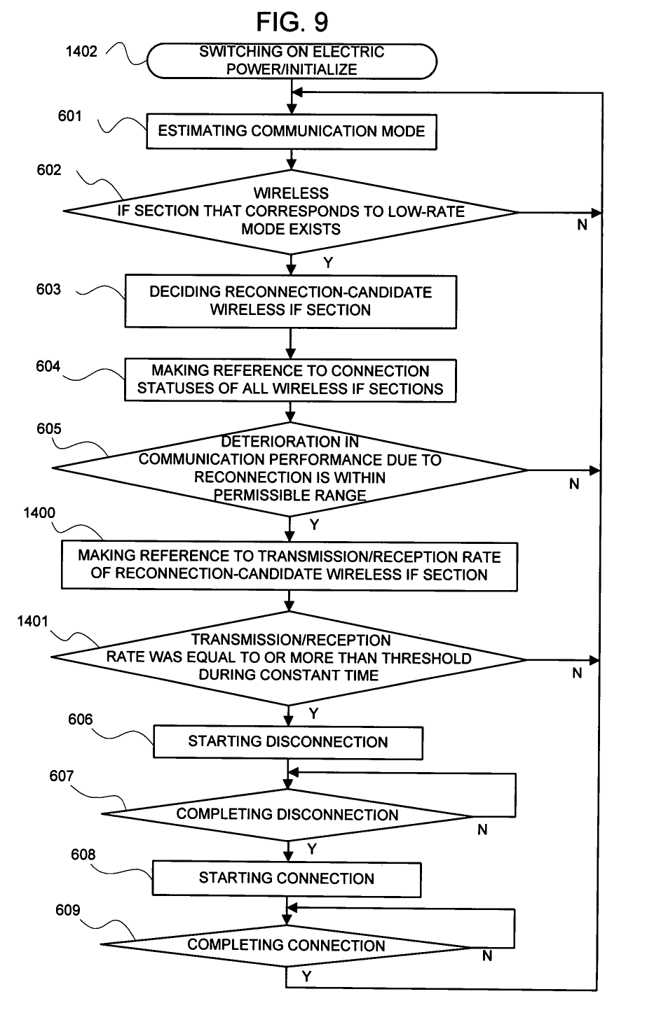

Next, an operation of the communication apparatus 10 in this example is shown, by making a reference to FIG. 9. Step 601 to step 609 are identical to that of the example 1, so its explanation is omitted herein.

In this example, in an initialize of a step 1402, the setting information memory storage 514 outputs the threshold for determining the transmission/reception rate and the determination time to the reconnection timing determining means 504 in addition to the process in the step 600 of the initialize of the example 1.

Further, in this example, after the reconnection timing determining means 504 has determined that the deterioration in the communication performance due to the reconnection is within a permissible range (step 605: Y), it acquires the transmission/reception rate for each unit time of the determination time notified to the setting information memory storage 1306 from the reconnection-candidate wireless IF section (step 1400).

If the transmission/reception rate for each unit time of the determination time is equal to or more than the threshold, the reconnection timing determining means 504 determines that this timing is a timing at which the reconnection should be performed (step 1401: Y), and the reconnection process of the step 606 to the step 609 is executed. In a case where the transmission/reception rate, which has not reached the threshold for determination, is included in the transmission/reception rates of the reconnection-candidate wireless IF section of the determination time (step 1401: N), the reconnection is not performed and the operation returns to the step 601.

As mentioned above, this example makes it possible to curtail a communication interruption time due to the unnecessary reconnection. The reason is that the reconnection is performed for the line, for which the line provider has applied a policy of preferentially assigning the high-rate communication mode to the line in which many traffics are occurring, only in a status where the transmission rate or the reception rate of the IF that is going to perform the reconnection process is equal to or more than the threshold for a constant time in succession, and yet the possibility that the high-rate communication mode can be assigned.

Additionally, in this example, the transmission/reception rate and the investigation result as to whether the deterioration in the communication performance due to the reconnection is within a permissible range are employed for the determination of the reconnection timing. The extent of the deterioration in the communication performance due to the reconnection may not be employed for the determination of the reconnection timing. In this case, it is self-evident that the relating means and steps are omitted.

### EXAMPLE 6

Next, an example 6 of the present invention will be explained.

In the example 6 of the present invention, the communication apparatus 10 of the example 1 is configured to include all of configurations of the example 2 to the example 5 in principle. Hereinafter, the portion in which the example 6 differs from each of the example 1 to the example 5 will be explained.

A network configuration in this example is identical to that of the example 1 shown in FIG. 2, so its explanation is omitted herein.

An internal structure of the communication apparatus 10 of this example is a structure that is obtained by adding the internal structures of the example 2 to the example 5 in all to that of the example 1. That is, the means and the function sections of FIG. 5 illustrating the internal structure of the example 3 provides the functions as well in the examples 2, 4, and 5 in all.

The position measuring means 901, however, has a function as well of the migration speed acquiring means 1101 in FIG. 7 of the example 4. The reason is that implementing a time differential calculus operation of the acquired position in a case where the position measuring means 901 is realized with the GPS makes it possible to acquire the migration speed as well, and implementing a time integral calculus operation of the acquired acceleration in a case where the position measuring means 901 is realized with the accelerometer makes it possible to acquire the migration speed as well.

Further, the setting information memory storage 514 has a function of pre-storing which criterion, out of a plurality of criteria for determining the reconnection timing, is essential, and the threshold as well for allowing a determination that the reconnection should be performed to be made, being the number of the unessential criterion with which the check result demonstrates that this timing is a timing at which the reconnection should be performed, in addition to a configuration of the example 1 to the example 5. These values are output to the reconnection timing determining means 900.

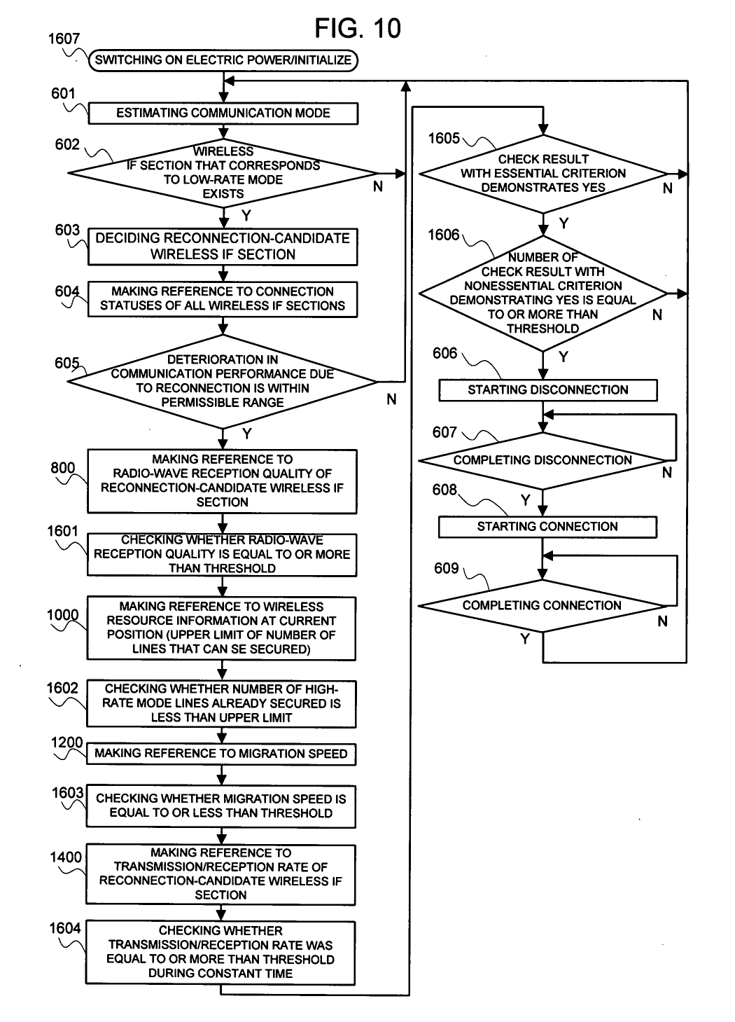

Next, an operation of the communication apparatus 10 in this example will be explained by making a reference to FIG. 10. In this example, the processes of step 1601 to step 1607 are different from that of the example 1 to the example 5.

At first, in the step 1607, the process, which is obtained by combining the processes of the corresponding portions of the example 1 to the example 5 in all, is performed. That is, various kinds of the thresholds, etc. stored by the setting information memory storage 514 are output to the reconnection timing determining means 900 and the communication mode estimating means 903.

Next, in the steps 1601 to 1604, the reconnection timing determining means 900 does not determine the reconnection timing instantly after checking whether this timing is a timing at which the reconnection should be performed, which differs from the case of the corresponding portions of the example 2 to the example 5. For example, in the step 1001 of the example 3, the reconnection timing determining means 900 instantly determined that this timing was a timing at which the reconnection had to be performed in a case where the number of the already-secured high-rate mode lines was less than the upper limit.

In this example, however, after the reconnection timing determining means 900 makes a similar check in the step 1602, it makes a check on the migration speed of the step 1200 and the step 1603 in succession.

After the reconnection timing determining means 900 has checked the reconnection timing by employing various kinds of information obtained up to the step 1604, it investigates how many check results with the essential criteria demonstrate that this timing is a timing at which the reconnection should be performed (step 1605).

Next, if the all check results with the essential criterion indicate that this timing is a timing at which the reconnection should be performed (step 1605: Y), the reconnection timing determining means 900 determines whether the number of the check results with the remaining unessential criterion demonstrating that this timing is a timing at which the reconnection should be performed is equal to or more than the threshold (step 1606). If it is equal to or more than the threshold, the reconnection timing determining means 900 determines that this timing is a timing at which the reconnection should be performed (step 1606: Y).

Hereafter, the reconnection process of the steps 606 to 609 is performed.

In a case where the reconnection timing determining means 900 has determined that this timing is a timing at which the reconnection should not be performed (step 1605: N), the operation returns to the step 601.

Additionally, in this example, the communication apparatus 10 of the example 1 has been entirely function-extended with the functions shown in the examples 2 to 5; however, it may be function-extended partially so long as the number of the extended function may be plural. In a case where the communication apparatus 10 is partially function-extended, it includes only the means and the functions that correspond to the extension portion, and it also includes only the operation of the step that corresponds to the extension portion, out of the operations shown in FIG. 10, is executed.

### EXAMPLE 7

An example 7 of the present invention will be explained.

As apparent from the explanation described in the foregoing examples, it is possible to configure the data transmitting means 524, the link controlling means 503, the reconnection timing determining means 504, the communication mode estimating means 505 of the communication apparatus 10 with hardware; however it is also possible to realize them with a computer program.

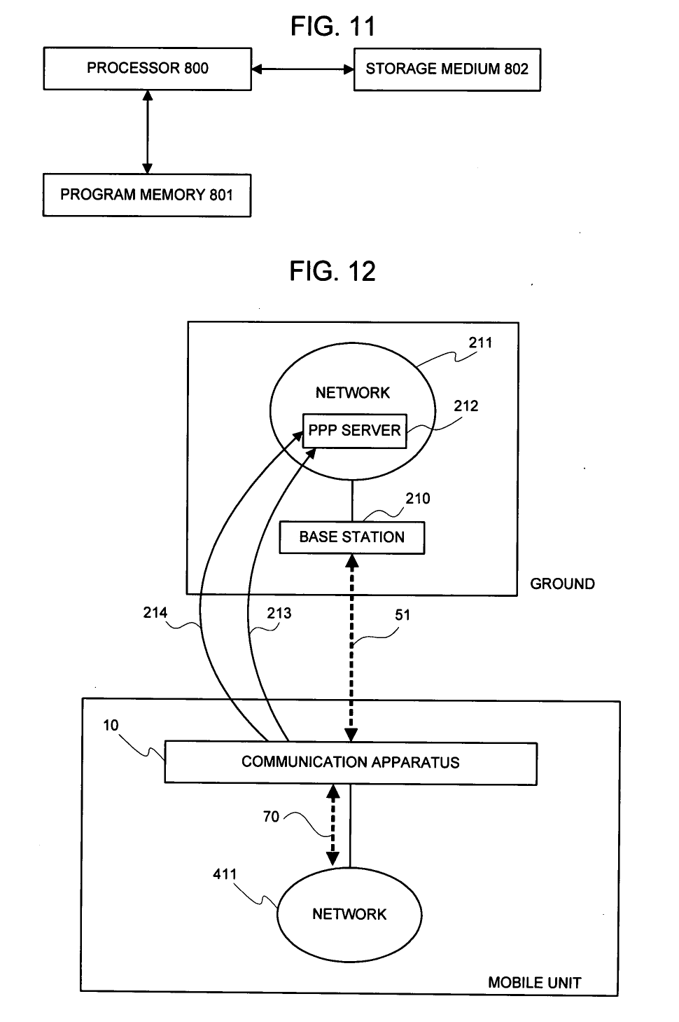

FIG. 11 is a general block configuration view of an information processing system having the data transmitting means 524, the link controlling means 503, the reconnection timing determining means 504, the communication mode estimating means 505 of the communication apparatus 10 implemented.

The information processing system shown in FIG. 11 is comprised of a processor 800, a program memory 801, and a storage medium 802. The storage medium 802 may be a separate storage medium, and may be a storage region that is comprised of an identical storage medium. As a storage medium, a magnetic storage medium such as a hard disk can be employed.

A program for allowing the operation similar to that of the foregoing data transmitting means 524, link controlling means 503, reconnection timing determining means 504, and communication mode estimating means 505 to be executed is filed into the program memory 801, and the processor 800, which operates under this program, performs the processes similar to that of the example 1 to the example 6.

### EXAMPLE 8

Next, an example 8 of the present invention will be explained.

In the example 8 of the present invention, one part of the functions that the communication apparatus 10 in the foregoing examples 1 to 7 provides is shifted to the server that exists on the ground side. Hereinafter, the portion in which the example 8 differs from the foregoing examples 1 to 7 will be explained.

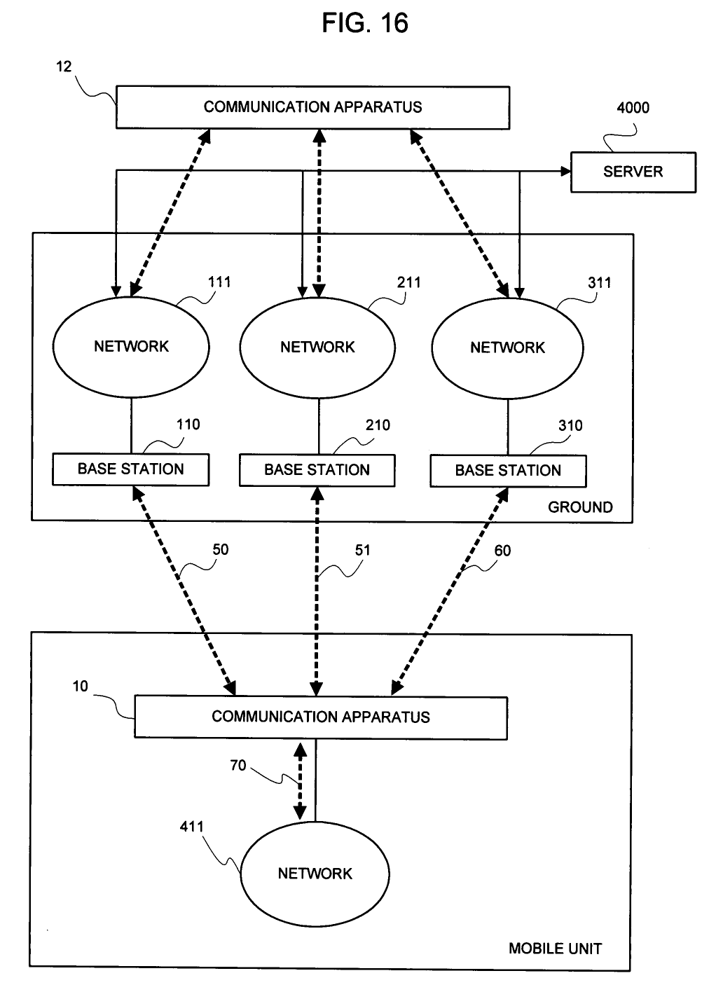

FIG. 16 shows a network configuration in the example 8. In this example, a link control system including a server 4000 and the communication apparatus 10 is configured.

The server 4000, which has one part of the functions that the communication apparatus 10 in the foregoing examples 1 to 7 provides, specifically includes the communication mode estimating means 505, the reconnection timing determining means 504, the setting information memory storage 514, etc. The communication mode estimating means 505, the reconnection timing determining means 504, and the setting information memory storage 514 mounted onto the server 4000 estimate each communication mode in the communication apparatus 10, acquire information necessary for determining the reconnection timing such as the connection status of the line and the band information from the wireless IF sections 500 to 502, determine the reconnection timing, and give an instruction for disconnecting and reconnecting the line similarly to that of the foregoing examples.

The wireless IF sections 500 to 502 of the communication apparatus 10 transmit the connection status of the line and the band information to the server 4000 responding to a request for information from the server 4000. Further, it disconnects the line responding to an instruction for disconnecting the line by the server 4000, and reconnects the line thereafter.

Making a configuration in such a manner makes it possible to obtain en effect similar to that of the foregoing examples, and further to realize simplification as well of the configuration of the communication apparatus 10.

### HOW THE INVENTION IS CAPABLE OF INDUSTRIAL EXPLOITATION

In the foregoing embodiment of the present invention, the switchover of the communication mode for a purpose of enlarging the band that was possible to utilize for communication was explained; however the present invention may be used in switching the communication mode for another purpose.

1-31. (canceled)

32. A communication apparatus for communicating using a line that corresponds to a plurality of communication modes, of which does not automatically switch to the high-rate communication mode from the low-rate communication mode by processing of the network, comprising:
a reconnection controlling means for disconnecting a line, and reconnecting the line with a connectee of said disconnected line.

33. A communication apparatus for combining lines each corresponding to a plurality of communication modes, of which do not automatically switch to the high-rate communication mode from the low-rate communication mode by processing of the network, configuring one logical line between transmission and reception, and making communication by employing said one logical line, comprising:
a reconnection controlling means for disconnecting at least one line, out of the lines constituting said one logical line, and reconnecting the line with a connectee of said disconnected line.

34. The communication apparatus according to claim 33, wherein said reconnection controlling means comprises:
a line status monitoring means for monitoring a line status of the connected line;
a reconnection timing determining means for determining a timing of the reconnection based upon a monitoring result by said line status monitoring means; and
a link controlling means for disconnecting the line based upon a determination by said reconnection timing determining means, and reconnecting the line with the connectee of said disconnected line.

35. The communication apparatus according to claim 32, wherein said reconnection controlling means comprises:
a communication mode estimating means for estimating a communication mode of the connected line;
a reconnection timing determining means for, in a case where an estimation result by said communication mode estimating means demonstrates that the communication mode is a low-rate communication mode, determining that the reconnection should be performed; and
a link controlling means for disconnecting the line based upon a determination by said reconnection timing determining means and reconnecting the line with the connectee of said disconnected line.

36. The communication apparatus according to claim 32, wherein said reconnection controlling means comprises:
a connection status acquiring means for detecting the number of the lines in a disconnection status;
a reconnection timing determining means for, with the predetermined number of the lines in a disconnection status assumed to be a criterion for determining the reconnection, determining that the reconnection should be performed when the number of the lines in a disconnection status, being a detection result by said connection status acquiring means, is less than said criterion for determining the reconnection; and
a link controlling means for disconnecting the line based upon a determination by said reconnection timing determining means and reconnecting the line with the connectee of said disconnected line.

37. The communication apparatus according to claim 32, wherein said reconnection controlling means comprises:
a band information acquiring means for detecting a communication band value of the connected line;
a reconnection timing determining means for, with a predetermined total communication band value assumed to be a criterion for determining the reconnection, determining that the reconnection should be performed when a total value of the lines other than the line being reconnected, being an acquisition result by said band information acquiring means, is more than said criterion for determining the reconnection; and
a link controlling means for disconnecting the line based upon a determination by said reconnection timing determining means and reconnecting the line with the connectee of said disconnected line.

38. The communication apparatus according to claim 32, wherein said reconnection controlling means comprises:
a radio-wave reception quality acquiring means for acquiring a reception quality of a radio wave of the line;
a reconnection timing determining means for, with a predetermined reception quality of a radio wave assumed to be a criterion for determining the reconnection, determining that the reconnection should be performed in a case where the reception quality of a radio wave, being an acquisition result by said radio-wave reception quality acquiring means, is larger than said criterion value for determining the reconnection; and
a link controlling means for disconnecting the line based upon a determination by said reconnection timing determining means and reconnecting the line with the connectee of said disconnected line.

39. The communication apparatus according to claim 32, wherein said reconnection controlling means comprises:
a communication mode estimating means for detecting the number of the lines using a high-rate communication mode;
a position acquiring means for acquiring a current position of the communication apparatus;
a reconnection timing determining means for, with the number of the lines, in which the high-rate communication mode can be secured, predetermined at each location assumed to be a criterion for determining the reconnection, determining that the reconnection should be performed in a case where the number of the lines using the high-rate communication mode, being a detection result by said communication mode estimating means, does not reached said criterion value for determining the reconnection at the location acquired by said position acquiring means; and
a link controlling means for disconnecting the line based upon a determination by said reconnection timing determining means and reconnecting the line with the connectee of said disconnected line.

40. The communication apparatus according to claim 32, wherein said reconnection controlling means comprises:
a migration speed acquiring means for acquiring a migration speed;
a reconnection timing determining means for, with a predetermined migration speed assumed to be a criterion for determining the reconnection, determining that the reconnection should be performed in a case where the migration speed, being an acquisition result by said migration speed acquiring means, is lower than said criterion value for determining the reconnection; and
a link controlling means for disconnecting the line based upon a determination by said reconnection timing determining means and reconnecting the line with the connectee of said disconnected line.

41. The communication apparatus according to claim 32, wherein said reconnection controlling means comprises:
a communication rate acquiring means for acquiring a communication rate per hour of the connected line;
a reconnection timing determining means for with a communication rate per hour in a predetermined time assumed to be a criterion for determining the reconnection, determining that the reconnection should be performed in a case where the communication rate per hour, being an acquisition result by said communication rate acquiring means, is larger than said criterion value for determining the reconnection during said predetermined time; and
a link controlling means for disconnecting the line based upon a determination by said reconnection timing determining means and reconnecting the line with the connectee of said disconnected line.

42. A communication method of communicating using a line that corresponds to a plurality of communication modes, of which does not automatically switch to the high-rate communication mode from the low-rate communication mode by processing of the network, the method comprising:
making an attempt to make a switchover to a high-rate communication mode by disconnecting the connected line, and
reconnecting the line with a connectee of said disconnected line.

43. A communication method of combining lines each corresponding to a plurality of communication modes, of which do not automatically switch to the high-rate communication mode from the low-rate communication mode by processing of the network, configuring one logical line between transmission and reception, and making communication by employing said one logical line, the method comprising:
making an attempt to make a switchover to a high-rate communication mode by disconnecting at least one line, out of the lines constituting said one logical line, and reconnecting the line with a connectee of said disconnected line.

44. The communication method according to claim 42, further comprising:
monitoring a line status of the connected line, and
determining a timing of the reconnection based upon a monitoring result.

45. The communication method according to claim 42, further comprising:
estimating a communication mode of the connected line, and
performing the reconnection in a case where the estimated communication mode is a low-rate communication mode.

46. The communication method according to claim 42, further comprising:
performing the reconnection when the number of the lines in a disconnection status is less than a predetermined number of the lines in a disconnection status.

47. The communication method according to claim 42, further comprising:
performing the reconnection when a total communication band value of the lines other than the line that is reconnected is more than a predetermined total communication band value.

48. The communication method according to claim 42, further comprising:
performing the reconnection when a radio-wave reception quality of the line is higher than a predetermined radio-wave reception quality.

49. The communication method according to claim 42, further comprising:
pre-storing the number of the high-rate communication mode lines that can be secured at each location, and
performing the reconnection in case where the number of the high-rate communication mode lines that are being used at a position in which the communication apparatus exists does not reached the number of the high-rate communication mode lines that can be secured in said position.

50. The communication method according to claim 42, further comprising:
pre-storing a predetermined migration speed, and
performing the reconnection in a case where the migration speed of the communication apparatus is lower than said predetermined migration speed.

51. The communication method according to claim 42, further comprising:
pre-storing a communication rate per hour of a predetermined time, and performing the reconnection in a case where the communication rate per hour of the connected line during a predetermined time is larger than said stored communication rate per hour.

52. A program product of storing a program of a communication apparatus for communicating using a line that corresponds to a plurality of communication modes, of which does not automatically switch to the high-rate communication mode from the low-rate communication mode by processing of the network, the program product, when executed by a computer, causing said communication apparatus to function as a reconnection controlling means for disconnecting the line, and reconnecting the line with a connectee of said disconnected line.

53. A program product storing a program of a communication apparatus for combining lines each corresponding to a plurality of communication modes, of which do not automatically switch to the high-rate communication mode from the low-rate communication mode by processing of the network, configuring one logical line between transmission and reception, and making communication by employing said one logical line, the program product, when executed by a computer, causing said communication apparatus to function as a reconnection controlling means for disconnecting at least one line, out of the lines constituting said one logical line, and reconnecting the line with a connectee of said disconnected line.

54. The program according to claim 52, wherein the program product, when executed by said computer, causing said reconnection controlling means to further function as:
a line status monitoring means for monitoring a line status of the connected line;
a reconnection timing determining means for determining a timing of the reconnection based upon a monitoring result by said line status monitoring means; and
a link controlling means for disconnecting the line based upon a determination by said reconnection timing determining means, and reconnecting the line with the connectee of said disconnected line.

55. The program according to claim 52, wherein the program product, when executed by said computer, causing said reconnection controlling means to further function as:
a communication mode estimating means for estimating a communication mode of the connected line;
a reconnection timing determining means for, in a case where an estimation result by said communication mode estimating means demonstrates that the communication mode is a low-rate communication mode, determining that the reconnection should be performed; and
a link controlling means for disconnecting the line based upon a determination by said reconnection timing determining means and reconnecting the line with the connectee of said disconnected line.

56. The program according to claim 52, wherein the program product, when executed by said computer, causing said reconnection controlling means to further function as:
a connection status acquiring means for detecting the number of the lines in a disconnection status;
a reconnection timing determining means for, with the predetermined number of the lines in a disconnection status assumed to be a criterion for determining the reconnection, determining that the reconnection should be performed when the number of the lines in a disconnection status, being a detection result by said connection status acquiring means, is less than said criterion for determining the reconnection; and
a link controlling means for disconnecting the line based upon a determination by said reconnection timing determining means and reconnecting the line with the connectee of said disconnected line.

57. The program according to claim 52, wherein the program product, when executed by said computer, causing said reconnection controlling means to further function as:
a band information acquiring means for detecting a communication band value of the connected line;
a reconnection timing determining means for, with a predetermined total communication band value assumed to be a criterion for determining the reconnection, determining that the reconnection should be performed when a total value of the lines other than the line being reconnected, being an acquisition result by said band information acquiring means, is more than said criterion for determining the reconnection; and
a link controlling means for disconnecting the line based upon a determination by said reconnection timing determining means and reconnecting the line with the connectee of said disconnected line.

58. The program according to claim 52, wherein the program product, when executed by said computer, causing said reconnection controlling means to further function as:
a radio-wave reception quality acquiring means for acquiring a reception quality of a radio wave of the line;
a reconnection timing determining means for, with a predetermined reception quality of a radio wave assumed to be a criterion for determining the reconnection, determining that the reconnection should be performed in a case where the reception quality of a radio wave, being an acquisition result by said radio-wave reception quality acquiring means, is larger than said criterion value for determining the reconnection; and
a link controlling means for disconnecting the line based upon a determination by said reconnection timing determining means and reconnecting the line with the connectee of said disconnected line.

59. The program according to claim 52, wherein the program product, when executed by said computer, causing said reconnection controlling means to further function as:
a communication mode estimating means for detecting the number of the lines using a high-rate communication mode;
a position acquiring means for acquiring a current position of the communication apparatus;
a reconnection timing determining means for, with the number of the lines, in which the high-rate communication mode can be secured, predetermined at each location assumed to be a criterion for determining the reconnection, determining that the reconnection should be performed in a case where the number of the lines using the high-rate communication mode, being a detection result by said communication mode estimating means, does not reached said criterion value for determining the reconnection at the location acquired by said position acquiring means; and
a link controlling means for disconnecting the line based upon a determination by said reconnection timing determining means and reconnecting the line with the connectee of said disconnected line.

60. The program according to claim 52, wherein the program product, when executed by said computer, causing said reconnection controlling means to further function as:
a migration speed acquiring means for acquiring a migration speed;
a reconnection timing determining means for, with a predetermined migration speed assumed to be a criterion for determining the reconnection, determining that the reconnection should be performed in a case where the migration speed, being an acquisition result by said migration speed acquiring means, is lower than said criterion value for determining the reconnection; and
a link controlling means for disconnecting the line based upon a determination by said reconnection timing determining means and reconnecting the line with the connectee of said disconnected line.

61. The program according to claim 52, wherein the program product, when executed by said computer, causing said reconnection controlling means to further function as:
a communication rate acquiring means for acquiring a communication rate per hour of the connected line;
a reconnection timing determining means for with a communication rate per hour in a predetermined time assumed to be a criterion for determining the reconnection, determining that the reconnection should be performed in a case where the communication rate per hour, being an acquisition result by said communication rate acquiring means, is larger than said criterion value for determining the reconnection during said predetermined time; and
a link controlling means for disconnecting the line based upon a determination by said reconnection timing determining means and reconnecting the line with the connectee of said disconnected line.

62. A server for managing a communication apparatus for communicating using a line that corresponds to a plurality of communication modes, of which does not automatically switch to the high-rate communication mode from the low-rate communication mode by processing of the network, the server comprising:
means for acquiring a line status of the communication apparatus;
means for deciding a disconnection timing of the line of said communication apparatus based upon said acquired line status; and
means for notifying said disconnection timing of the line to said communication apparatus.
